(19) United States
(12) Patent Application Publication
(10) Pub. No.: US 2019/0354855 A1
(43) Pub. Date: Nov. 21, 2019

(54) METHOD FOR CALCULATING SIMILARITY OF CASES BASED ON CITATION RELATIONSHIP

(71) Applicant: CoreDotToday Inc., Ulju-gun (KR)

(72) Inventors: Kyung Hoon KIM, Ulsan (KR); Seul Gi OH, Ulsan (KR); Bong Soo JANG, Ulsan (KR)

(73) Assignee: CoreDotToday Inc., Ulju-gun (KR)

(21) Appl. No.: 16/007,215

(22) Filed: Jun. 13, 2018

(30) Foreign Application Priority Data
May 15, 2018 (KR) 10-2018-0055633

(51) Int. Cl. G06N 3/08; G06F 17/27

(52) U.S. Cl. CPC G06N 3/08; G06F 17/2785

(57) ABSTRACT

Disclosed is a method for calculating a similarity of cases based on a citation relationship. The method includes receiving a learning dataset on specific cases, machine-learning the learning dataset by using a neural network learning model, and calculating a similarity of the specific cases according to a machine-learning result, wherein the learning dataset includes an input layer in which each of identifiers of the specific cases includes a one-hot vector, and an output layer in which each of identifiers of one or more provisions of a legislation cited on written judgments of the cases includes a one-hot vector.

### CROSS-REFERENCE TO RELATED APPLICATIONS

A claim for priority under 35 U.S.C. § 119 is made to Korean Patent Application No. 10-2018-0055633 filed May 15, 2018, in the Korean Intellectual Property Office, the entire contents of which are hereby incorporated by reference.

### BACKGROUND

Embodiments of the inventive concept described herein relate to natural language processing (NLP) using an artificial intelligence, and more particularly, to a method for calculating a similarity of cases based on a citation relationship.

Legal information includes various pieces of information, such as provisions, cases, written judgments, decisions, and inquiries/responses of legislations, and among them, the cases refer to determinations made by interpreting and applying a law to a specific case by a court. The cases are substantially precedents and are answer sheets of written judgments.

Because the legal information becomes very complex over time (the amount of the legal information increases and the contents of the legal information is versified), a good tool for dealing with the complexity is necessary. Further, a natural language processing technology of an artificial intelligence field is being studied as a tool.

Word2Vec is a learning scheme of word embedding that expresses words in the form of a vector again. The core of Word2Vec is to determine and arrange a value of a vector such that words having the same context may be calculated as similar values. The scheme is based on a linguistic assumption called ‘assumption of distribution’ that tells that words having similar distributions have similar meanings. For example, because ‘a solid line’ and ‘a central line’ have common contexts of ‘a road’ and ‘intrudes’ in two sentences of ‘intrudes a solid line of a road’ and ‘intrudes a central line of a road’, it is interpreted that ‘a solid line’ and ‘a central line’ have similar meanings. The Word2Vec is not suitable for calculating a sematic similarity (or a content similarity) of cases. This is because a case includes very many unnecessary words as well as contents for a principle of law that is to be expressed by the case. For example, in the case of a case regarding a patent, many unnecessary words that are not relevant to a principle of law, for example, by writing all of the title of the target patent invention and the elements thereof, are included. Accordingly, it is difficult to calculate a sematic similarity of cased only with a word-based algorithm.

Meanwhile, Kim Nari, Kim Hyungjung, ‘Study on Word Embedding-based Law2Vec Model for Searching for Associated Legislation’, Digital contents associate paper, Vol. 18, No. 7, 2017, pp. 1419-1425 suggests a method for calculating a sematic calculation between legislations by using a citation relationship of legislations. The suggested method utilizes only legislations instead of words while employing a structure of Word2Vec as it is. That is, in the suggested method, legislations cited by cases are treated as one sentence, and the legislations are treated as words in one sentence to apply Word2Vec. According to the method, only a sematic similarity of legislations may be calculated. Further, the legislations cited by one case do not have the same meaning but relate to the principles of law on several points of arguments of cases dealt by the case, and accordingly, the accuracy of the method is as low as about 57%. For example, Seoul Central Local Court 2010 GoHap 147 Judgment cites Inheritance Tax and Gist Tax Act Decree 54 and Criminal Law 20, and according to the method, it is interpreted that two legislations having completely different meanings are similar in their semantics.

### SUMMARY

Embodiments of the inventive concept provide a method for calculating a similarity of cases more accurately.

The technical objects of the inventive concept are not limited to the above-mentioned ones, and the other unmentioned technical objects will become apparent to those skilled in the art from the following description.

In accordance with an aspect of the inventive concept, there is provided a method for calculating a similarity of cases based on a citation relationship, the method being realized by a computer, the method including receiving a learning dataset on specific cases, machine-learning the learning dataset by using a neural network learning model, and calculating a similarity of the specific cases according to a machine-learning result, wherein the learning dataset includes an input layer in which each of identifiers of the specific cases includes a one-hot vector, and an output layer in which each of identifiers of one or more provisions of a legislation cited on written judgments of the cases includes a one-hot vector.

In accordance with another aspect of the inventive concept, there is provided a method for calculating a similarity of cases based on a citation relationship, the method being realized by a computer, the method including receiving a learning dataset on specific cases, machine-learning the learning dataset by using a neural network learning model, and calculating a similarity of cases according to a machine-learning result, wherein the learning dataset includes an input layer in which each of identifiers of the specific cases includes a one-hot vector, and an output layer in which each of identifiers of one or more other cases cited on written judgments of the specific cases includes a one-hot vector.

In accordance with another aspect of the inventive concept, there is provided a method for calculating a similarity of cases based on a citation relationship, the method being realized by a computer, the method including receiving a learning dataset on specific cases, machine-learning the learning dataset by using a neural network learning model, and calculating a similarity of cases according to a machine-learning result, wherein the learning dataset includes an input layer in which each of identifiers of the specific cases includes a one-hot vector, and a first output layer in which each of identifiers of one or more provisions of a legislation cited on written judgments of the cases includes a one-hot vector, and a second output layer in which each of identifiers of one or more other cases cited on the written judgments of the specific cases includes a one-hot vector.

### BRIEF DESCRIPTION OF THE FIGURES

The patent or application file contains at least one drawing executed in color. Copies of this patent or patent application publication with color drawing(s) will be provided by the Office upon request and payment of the necessary fee.

The above and other objects and features will become apparent from the following description with reference to the following figures, wherein like reference numerals refer to like parts throughout the various figures unless otherwise specified, and wherein:

FIG. 1 is a flowchart schematically illustrating a method for calculating a similarity of cases based on a citation relationship according to an embodiment of the inventive concept;

FIGS. 2 to 3 are views schematically illustrating a structure of a Word2Vec algorithm;

FIG. 4 is a view schematically illustrating an example of progressing learning of a Skip-gram model;

FIG. 5 is a graph schematically illustrating a distribution of matrix W1;

FIG. 6 is a graph schematically illustrating a distribution of matrix W2;

FIG. 7 is a view illustrating a heatmap of matrix W1;

FIG. 8 is a view illustrating a similarity of input nodes;

FIG. 9 is a view illustrating a heatmap of matrix W2;

FIG. 10 is a view illustrating a similarity of output nodes;

FIG. 11 is a view illustrating a heatmap of matrix W1 in a large-scale set;

FIG. 12 is a view illustrating a similarity of input nodes in a large-scale set;

FIG. 13 is a view illustrating a heatmap of matrix W2 in a large-scale set;

FIG. 14 is a view illustrating a similarity of output nodes in a large-scale set;

FIG. 15 is a view schematically illustrating a structure of a CL model;

FIG. 16 is a graph that visualizes a citation relationship of legislations of case No. 99 Du 9902;

FIG. 17 is a graph that visualizes a citation relationship of five example cases and a legislation;

FIG. 18 is a view schematically illustrating a structure of a CC model;

FIG. 19 is a graph that visualizes a citation relationship of cases of case No. 99 Du 9902;

FIG. 20 is a view schematically illustrating a structure of a CLC model;

FIG. 21 is a graph that visualizes a citation relationship of legislations and cases of case No. 99 Du 9902;

FIG. 22 is a graph that visualizes a citation relationship of sample cases;

FIG. 23 is a graph that visualizes a citation relationship of cases and legislations of an example case;

FIG. 24 is a view illustrating a heatmap of matrix W1 of a CL model;

FIG. 25 is a view illustrating a similarity of input nodes of a CL model;

FIG. 26 is a view illustrating a heatmap of matrix W2 of a CL model;

FIG. 27 is a view illustrating a similarity of output nodes of a CL model;

FIG. 28 is a graph that visualizes a citation relationship of cases of an example case;

FIG. 29 is a view illustrating a heatmap of matrix W1 of a CC model;

FIG. 30 is a view illustrating a similarity of input nodes of a CC model;

FIG. 31 is a view illustrating a heatmap of matrix W2 of a CC model;

FIG. 32 is a view illustrating a similarity of output nodes of a CC model;

FIG. 33 is a graph that visualizes a citation relationship of cases and legislations, and cases of an example case;

FIG. 34 is a view illustrating a heatmap of matrix W1 of a CLC model;

FIG. 35 is a view illustrating a similarity of input nodes of a CLC model;

FIG. 36 is a view illustrating a heatmap of matrix W2 of a CLC model;

FIG. 37 is a view illustrating a similarity of output nodes of a CLC model;

FIG. 38 is a graph depicting an evaluation result when the CL model is learned 10,000 times and 160,000 times;

FIG. 39 is a graph depicting an evaluation result when the CC model is learned 10,000 times and 160,000 times;

FIG. 40 is a graph depicting an evaluation result when the CLC model is learned 10,000 times and 160,000 times;

FIG. 41 is a view illustrating an association (similarity) probability list of cases and an example of prediction of a link by using the association probability list; and

FIG. 42 is a flowchart schematically illustrating a method for providing similar case information based on a citation relationship according to another embodiment of the inventive concept.

### DETAILED DESCRIPTION

The above and other aspects, features and advantages of the invention will become apparent from the following description of the following embodiments given in conjunction with the accompanying drawings. However, the inventive concept is not limited to the embodiments disclosed below, but may be implemented in various forms. The embodiments of the inventive concept is provided to make the disclosure of the inventive concept complete and fully inform those skilled in the art to which the inventive concept pertains of the scope of the inventive concept.

The terms used herein are provided to describe the embodiments but not to limit the inventive concept. In the specification, the singular forms include plural forms unless particularly mentioned. The terms “comprises” and/or “comprising” used herein does not exclude presence or addition of one or more other elements, in addition to the aforementioned elements. Throughout the specification, the same reference numerals dente the same elements, and “and/or” includes the respective elements and all combinations of the elements. Although “first”, “second” and the like are used to describe various elements, the elements are not limited by the terms. The terms are used simply to distinguish one element from other elements. Accordingly, it is apparent that a first element mentioned in the following may be a second element without departing from the spirit of the inventive concept.

Unless otherwise defined, all terms (including technical and scientific terms) used herein have the same meaning as commonly understood by those skilled in the art to which the inventive concept pertains. It will be further understood that terms, such as those defined in commonly used dictionaries, should be interpreted as having a meaning that is consistent with their meaning in the context of the specification and relevant art and should not be interpreted in an idealized or overly formal sense unless expressly so defined herein.

Hereinafter, exemplary embodiments of the inventive concept will be described in detail with reference to the accompanying drawings.

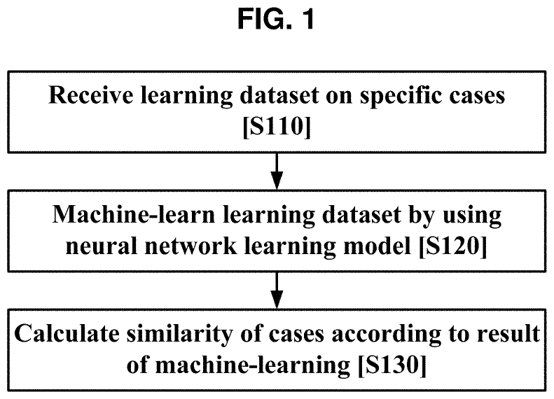

FIG. 1 is a flowchart schematically illustrating a method for calculating a similarity of cases based on a citation relationship according to an embodiment of the inventive concept.

Referring to FIG. 1, the method for calculating a similarity of cases includes an operation (S110) of receiving a learning dataset on specific cases, an operation (S120) of machine-learning the learning dataset by using a neural network learning model, and an operation (S130) of calculating a similarity of the specific cases according to a machine-learning result.

The learning dataset is classified into three models.

The first one is a case-legislation (CL) model. In the case-legislation model, the learning dataset includes an input layer in which each of identifiers of the specific cases includes a one-hot vector, and an output layer in which each of identifiers of one or more provisions of a legislation cited on written judgments of the specific cases includes a one-hot vector.

The identifiers of the cases may include the courts, the sentencing dates, the case signs, the case numbers, and the kinds (judgments or decisions) of the trials, and the like of the cases, but the inventive concept is not limited thereto. Further, the identifiers of the provisions of the legislation may include the name of the legislation and the numbers of the provisions, but the inventive concept is not limited thereto.

The next one is a case-case (CC) model. In the case-case model, the learning dataset includes an input layer in which each of identifiers of the specific cases includes a one-hot vector, and an output layer in which each of identifiers of one or more cases cited on written judgments of the cases includes a one-hot vector.

The last one is a case-legislation-case (CLC) model. In the case-legislation-case model, the learning dataset includes an input layer in which each of identifiers of specific cases includes a one-hot vector, a first output layer in which each of identifiers of one or more provisions of a legislation cited on written judgments of the specific cases includes a one-hot vector, and a second output layer in which each of identifiers of one or other cases cited on the written judgments of the specific cases includes a one-hot vector.

Hereinafter, a model structure, a performance verification result, and a link prediction application of the method for calculating a similarity of cases based on a citation relationship according to the embodiment of the inventive concept will be described in detail.

The inventors desired to introduce word embedding that is a natural language processing technology of a deep learning field as a tool for dealing with the complexity of legal information to find a solution. The legal information is cited to represent the logical structure and the decision becomes comprehensive. Accordingly, the inventors desired to show an embedding structure in which the relationship of the meta information (cited information) is learned and the semantic similarity of the cases may be calculated through the learned relationship. Because the case information is complex, it is difficult to calculate a similarity of cases with traditional text mining learning methods.

First, because there are actually no cases that do not depend on laws, existing cases are the best reference materials in the trials for the similar suits that occur later. Then, the determinations made in the trials always cite laws, and accordingly, the cases always cite the laws. Further, the cases also often cite existing preceding cases. The inventors desired to derive sematic information by using a citation relationship of the legal information.

### Model Structure

Vector space models (VSMs) have been used for a long time to mathematically express information of documents and methods, such as latent sematic indexing (LSI) and latent Dirichlet allocation (LDA), have been used traditionally, but recently, a Word2Vec method using artificial neural networks (ANNs) may been spotlighted. The Word2Vec method is a method for receiving a corpus as an input and expressing words of the corpus with a vector as one method of word embedding. The Word2Vec is expressed by a vector in consideration of the meaning and context of a word, and is calculated with an assumption called a distributional hypothesis of liquistics. Similar distributions mean that the words appear in the same context. For example, because Burger King and Mac Donald appear in the same context in “The hamburger of Burger King is delicious” and “The hamburger of Mac Donald”, they have similar meanings.

The Word2Vec was made public in 2013 by Mikolov[Mik+13], and later, various derived algorithms, such as sentense2vec, paragraph2vec, doc2vec, and lda2vec, have been introduced. The inventors desired to suggest a new structure that reflects a legal structure.

### 1. Word2Vec

The Word2Vec is one of word embedding methods for expressing a word with a vector again, and is an unsupervised learning algorithm for automatically learning a relationship between words based on a neurological network. The basic idea is that the words having similar meanings are located at similar locations. In order to calculate this, two methods are generally known. The methods are called CBOW and Skim-gram.

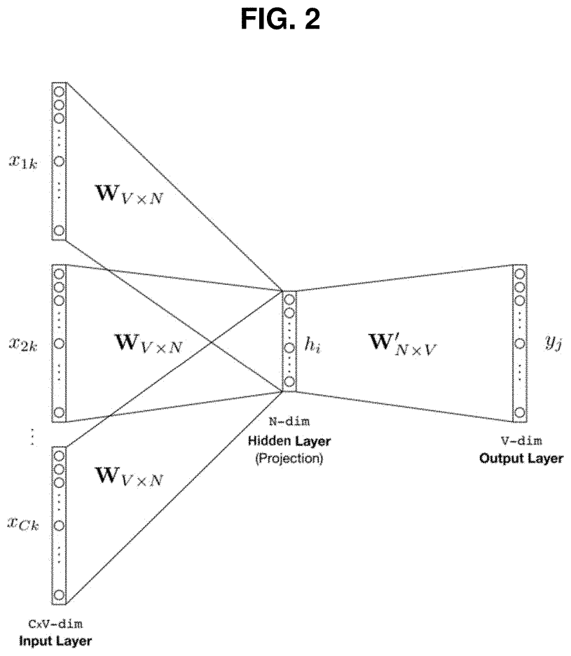

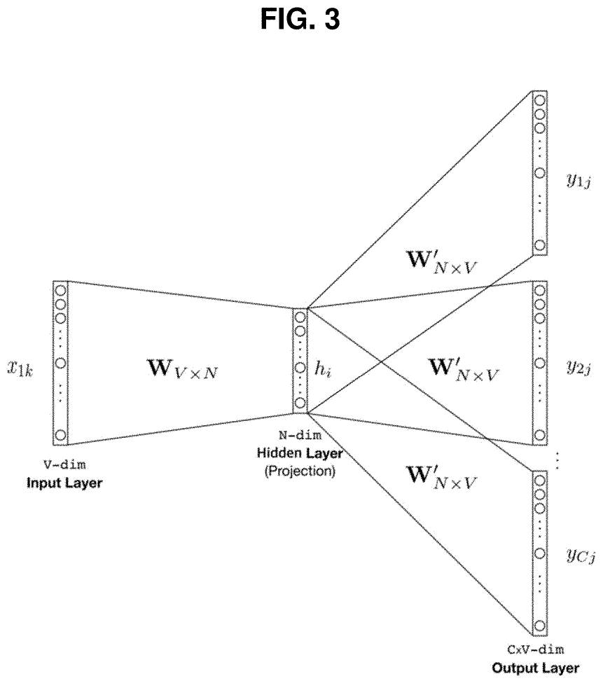

Referring to FIG. 2, in CBOW (continuous bag of words), a model is trained by inputting a context including C words and then a target word that appears adjacent to an input text is predicted. As can be seen in FIG. 2, for learning, context words are inserted into a left input layer and a target word is inserted into a right output layer. Meanwhile, referring to FIG. 3, in Skip-gram, a neurological network is trained by inputting a target word and then a set of contexts that appear around the target word is predicted. C is a window parameter and how far from a target word a context word is selected is set according to C. FIG. 3 expresses the structure.

The structure operates well even in legal text data. The result obtained by learning Word2Vec for 76,000 Korean cases is as in Table 1.

TABLE 1

| Target | | | |
|---|---|---|---|
| words | “ [symbol] ” (Trial) | “ [symbol] ” (Cheek) | “ [symbol] ” (College) |
| Similar | “ [symbol] ” (Suit) 0.47 | “ [symbol] ” (hair) 0.345 | “ [symbol] ” (university) 0.51 |
| words | “ [symbol] ” (retrial) 0.428 | “ [symbol] ” (fist) 0.342 | “ [symbol] ” (school) 0.485 |
| | “ [symbol] ” (imprisonment) 0.422 | “ [symbol] ” (battery) 0.32 | “ [symbol] ” (education) 0.379 |
| | “ [symbol] ” (appellate trial) | “ [symbol] ” (collar) 0.306 | “ [symbol] ” (college student) |
| | 0.385 | “ [symbol] ” (shin) 0.293 | 0.37 |
| | “ [symbol] ” (appeal) 0.371 | “ [symbol] ” (violence) 0.29 | “ [symbol] ” (academy) 0.343 |
| | “ [symbol] ” (judgment) 0.346 | “ [symbol] ” (talking down) | “ [symbol] ” (graduate school) |
| | “ [symbol] ” (file) 0.339 | 0.288 | 0.337 |
| | “ [symbol] ” (ruling) 0.324 | “ [symbol] ” (assault) 0.286 | “ [symbol] ” (department) 0.331 |
| | “ [symbol] ” (justice) 0.315 | “ [symbol] ” (punishment) | “ [symbol] ” (student) 0.328 |
| | “ [symbol] ” (court) 0.313 | 0.284 | “ [symbol] ” (professor) 0.325 |
| | | “ [symbol] ” (back head) | “ [symbol] ” (faculty) 0.318 |
| | | 0.284 | |

For example, let's assume that data given in sentences 1 and 2 is learned. First, the given data is separated into meaningful units by analyzing morphemes of the given data. Here, nouns are selected.

Sentence 1: A family comprised of a married immigrant under subparagraph 3 of Article 2 of the Framework Act on Treatment of Foreigners Residing in the Republic of Korea.

Nouns 1: family, immigrant, subparagraph, Article, Framework Act, Treatment, Foreigners, Korea

Sentence 2: The State and local governments shall endeavor to provide supportive services in diverse languages in promoting supportive policies under Articles 5 through 10 to eliminate difficulties that married immigrants and naturalized citizens, etc. may have in communication and improve accessibility to such services . . . .

Nouns 2: state, governments, services, languages, policies, citizens, communication, accessibility

Let's assume that the number C of the context words is 1. Then, the word lists of the sentences are constituted as follows.

[family, immigrant, subparagraph], [immigrant, subparagraph, Article], [subparagraph, Article, Framework Act], [Article, Framework Act, Treatment], [Framework Act, Treatment, Foreigners], [Treatment, Foreigners, Korea], [Foreigners, Korea, State], [Korea, State, governments], [State, governments, services], [governments, services, languages], [services, languages, policies], [languages, policies, citizens], [policies, citizens, communication], [citizens, communication, accessibility].

Here, the middle words are target words, and the side words are context words. Learning is started with the CBOW or Skip-gram structure.

In summary, the Word2Vec is characterized in that (1) a word has learning data and (2) a word has a relationship only with context data.

However, the learning method based on a work has a problem. If a given word does not well express the feature of a sentence, the word may be learned in a wrong way. In particular, it is more important to understand a principle of law or a fact relationship which a case itself states rather than a word. Accordingly, it is necessary to suggest a learning method other than a word based learning method to recognize the contents of a document. To achieve this, the inventors experimented a learning method of heterogeneous data for learning a citation relationship, and suggested Law2Vec (that is named Law2Vec as in ‘a study of a Law2Vec model based on word embedding for searching for associated legislation’ because it makes legislation information a vector to process the vector) for learning a relationship of legal data based on the result.

### 2. Heterogeneous Word2Vec

The meaning of ‘heterogeneous’ is that there are two types of learning data for an input layer and an output layer. In the case of two types of learning sets, let's discuss the following example to see how well the connection relationship of the learning sets is learned.

For example, let's assume a number list such as data={0, 1, 2, 3, 4, 5, 6}.

Here, if it is assumed that the side numbers have a relationship, let's assume that the numbers 1, 2, 3, 4, and 5 pertain to one data type having a relationship of side numbers and the numbers 0, 1, 2, 3, 4, 5, and 6 pertain to another data type having a connection relationship. For example, it is like the number 1 has a relationship with the numbers 0 and 2 and the number 2 has a relationship with the numbers 1 and 3. Now, let's the two types of datasets correspond to one-hot encoding as in Tables 2 and 3.

TABLE 2

| Word | One-hot encoding vector |
|---|---|
| 1 | [1, 0, 0, 0, 0] |
| 2 | [0, 1, 0, 0, 0] |
| 3 | [0, 0, 1, 0, 0] |
| 4 | [0, 0, 0, 1, 0] |
| 5 | [0, 0, 0, 0, 1] |

TABLE 3

| Word | One-hot encoding vector |
|---|---|
| 0 | [1, 0, 0, 0, 0, 0, 0] |
| 1 | [0, 1, 0, 0, 0, 0, 0] |
| 2 | [0, 0, 1, 0, 0, 0, 0] |
| 3 | [0, 0, 0, 1, 0, 0, 0] |
| 4 | [0, 0, 0, 0, 1, 0, 0] |
| 5 | [0, 0, 0, 0, 0, 1, 0] |
| 6 | [0, 0, 0, 0, 0, 0, 1] |

The relationship may be converted to a learning dataset in which target data and context data are combined with each other as in Table 4.

TABLE 4

| Category | Target data | Context data | Learning data set |
|---|---|---|---|
| Word | 1 | 0, 2 | [1, 0], [1, 2] |
| | 2 | 1, 3 | [2, 1], [2, 3] |
| | 3 | 2, 4 | [3, 2], [3, 4] |
| | 4 | 3, 5 | [4, 3], [4, 5] |
| | 5 | 4, 6 | [5, 4], [5, 6] |

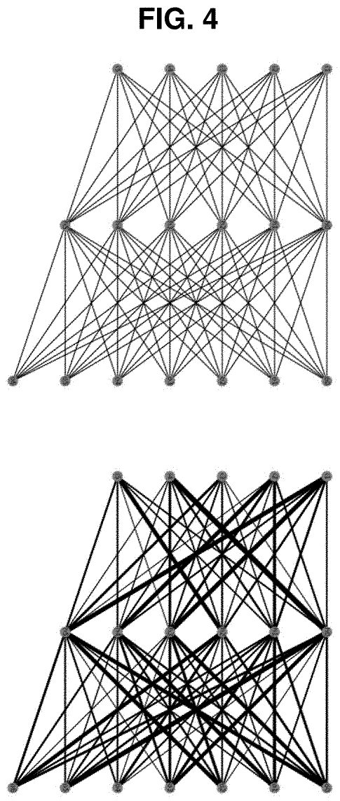

If a Skip-gram model as in FIG. 3 is learned with the converted relationship, the length of the input layer is the number of the target data of 5 and the length of the output layer is the number of the context data of 7. In addition, let's assume that the number of nodes of the hidden layer is 6. This is constituted and learned as in FIG. 4. The weighted values of edges that are given at random according to a uniform distribution at first are learned such that some of them are thick and some of them are thin as in the right side of FIG. 4.

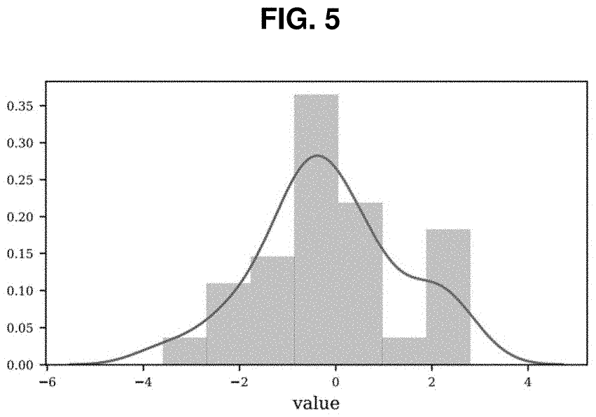

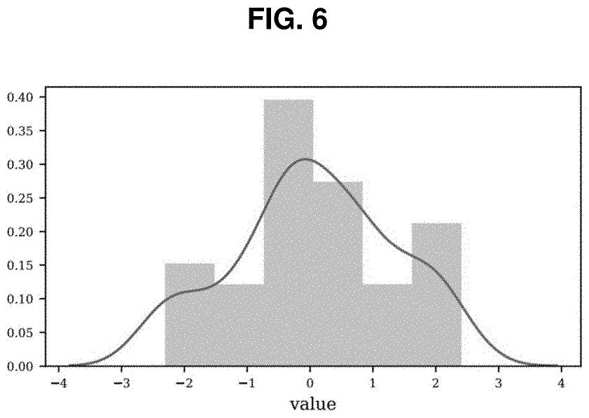

Let's assume that the values of the edges between the layers may be expressed as a matrix, a matrix between the input layer and the hidden layer is W1 and a matrix between the hidden layer and the output layer is W2. It can be seen that the values of the matrixes are well learned not to follow a uniform distribution and have large and small values as can be seen in FIGS. 5 and 6.

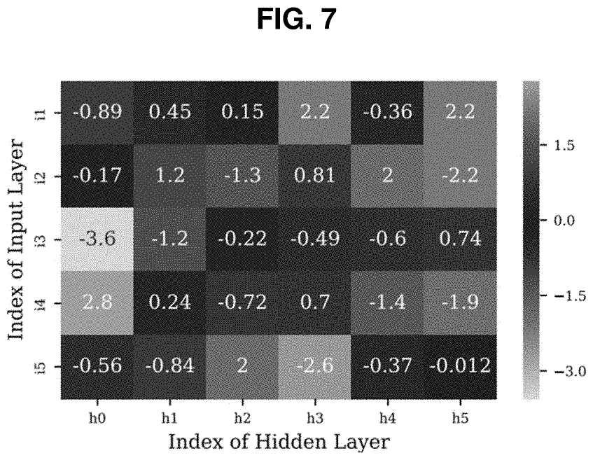

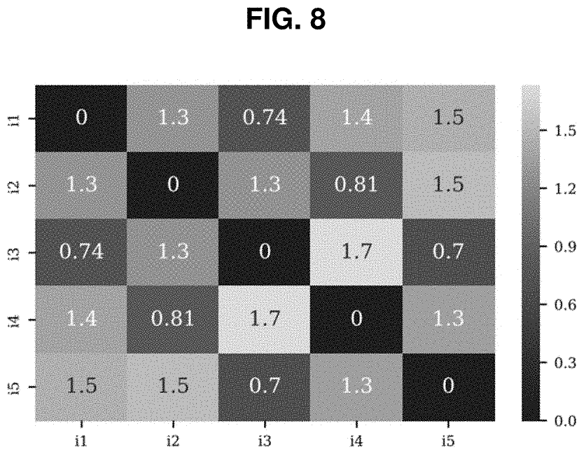

After the learning, the vectors for the numbers 1, 2, 3, 4, and 5 may be obtained through the matrix W1. The matrix W1 is visualized with a heatmap as in FIG. 7. In FIG. 7, the rows are vectors for the numbers. Accordingly, let's calculate similarities of the numbers to compare how similar the vectors are. Here, a Euclidean distance using a cosine similarity is used for a similarity. It means that the values of two vectors are more similar as the similarity approaches 0. In FIG. 8, the value 0 of (i1, i1) means a similarity of the number 1 and the number 1, and it means that the number 1 and the number 1 are naturally the same. It may be identified through the value (i1, i3) that a value that is the most similar to the number 1 is the number 3. It may be identified that the similarity of the number 2 and the number 2 is least and the number 3 is most similar to the number 1 and the number 5.

Similarly, also in the matrix W, the similarities of the numbers 0, 1, 2, 3, 4, 5, and 6 may be calculated.

It may be identified through the result that the numbers having the common relationship have very similar values. For example, it can be seen that the number 3 of the input data has a relationship with the numbers 2 and 4 of the output data and the numbers 1 and 5 of the input data having a relationship with the numbers 2 and 4 are most similar to the number 3. Let's discuss that the learning of the relationship is also well applied to a larger amount of learning.

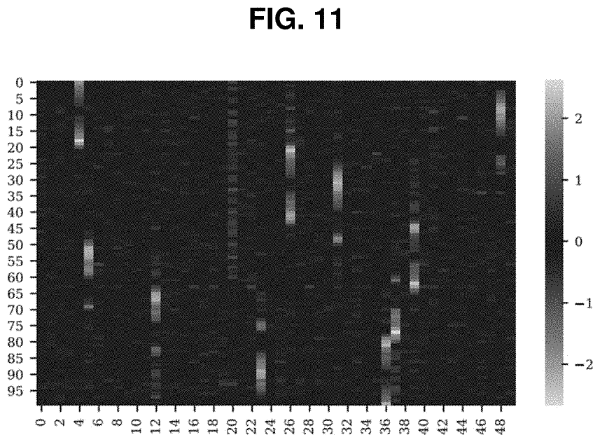

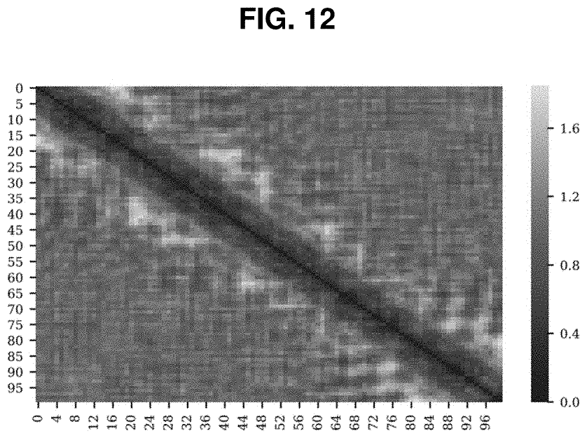

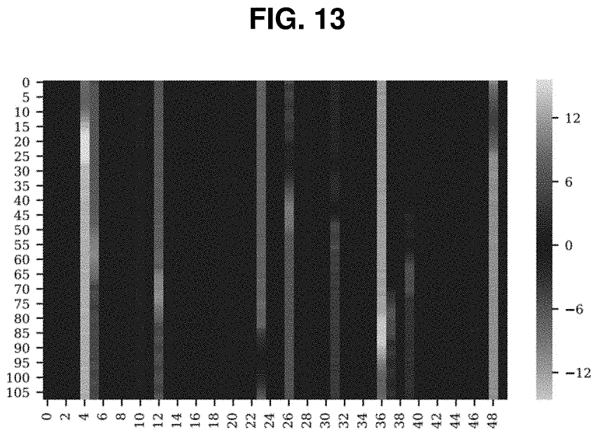

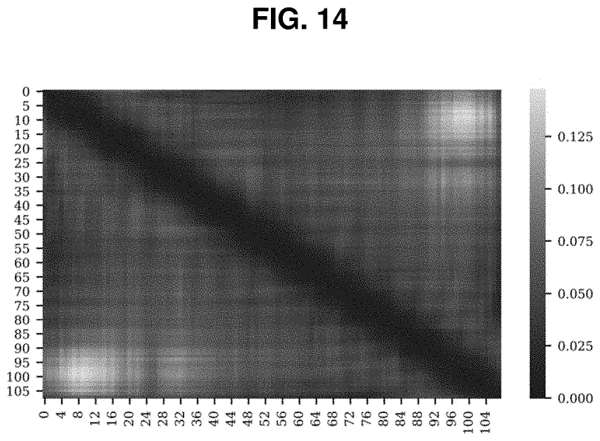

For example, let's assume that C of the numbers 0 to 108 is 4 and the number N of the hidden nodes is 50. It can be seen from the result that the learning is well performed as in FIGS. 11 to 14.

### 3. Law2Vec

The studies on calculation of semantic similarities of documents are fields that have been studied for a long time. In particular, the studies on the similarities of documents in the legal data field are technologies that are essentially necessary to develop a search engine or the like. Discovering a similar case or legislation that is helpful to solve a case which I make an effort to solve is essentially performed in the field such as a legal research or a case analysis, and a method of listing similarity scores in a descending order after calculating the similarity scores in the documents in a keyword matching scheme at the initial stage. However, in the keyword matching scheme, because it is referenced whether there is the same keyword, the similarity cannot be calculated properly as similar words or synonyms are evaluated as being absolutely different. To solve this, in the latent semantic indexing (LSI) scheme, various studies, such as finding synonyms by calculating an approximated matrix have been made. However, in all the studies, the words themselves are focused, and the direction is accompanied by a difficulty in discovering a meaning of a legal document, particularly, a case.

In cases, various events are described in the written judgments. For example, case No. 2007 Hu 3806 discloses an invention entitled ‘Water Cleaning Apparatus Having a Plurality of UV Lamps’ as the contents for identifying the scope of the patent. However, the words, such as ‘UV lamp’, ‘having’, and ‘water-cleaning apparatus’, are not necessary for calculating a similarity of the meanings of the case.

Calculating a similarity of meanings of a case means an issue of the case and a point for determining the issue, and very many unnecessary words appear in calculating the similarity of the topics. To solve this, a method, such as latent Dirichlet allocation, may be applied and this method is not suitable for solving the basic problem.

The inventors suggested a new structure that reflects a relationship between a case between a case and a legislation to represent the similarity. The inventors named the structure as Law2Vec, and three forms may be constituted by utilizing the case and the legislation information.

### 1) Case-Legislation (CL) Model

The laws do not describe the same contents. A regulated form of citing or applying the provision contents regulated in advance is selected. In order to make a decision of a case, the judge verifies the logic of the case by citing a legislation that acts as a base of the case. Accordingly, a reference legislation is always present in writing a written judgment, and a citation relationship between a case and a legislation is to be learned by using a Word2Vec structure.

A legislation contains a special topic in each of its provisions, and it may be said that a case is cited by specifying special topics. Accordingly, the search of similar contents of the case may be learned through citation relationships of the provisions.

Hereinafter, it will be shown that the search of the similarity that contains the meaning of a case by learning a relationship between the case and the citation legislations.

As can be seen from FIG. 5, the similarity is calculated by inserting a case into an input layer and reflecting cited legislations on an output layer. For example, case No. 99 Du 9902 refers to the provisions of Table 5.

TABLE 5

| | |
|---|---|
| 1 | “ [symbol] ( [symbol] )”(Environmental impact assessment act |
| | (old)) Article 1 |
| 2 | “ [symbol] · [symbol] · [symbol] ” (Environmental, traffic, |
| | disaster impact assessment act) Article 1 |
| 3 | Environmental impact assessment act (old) Article 4 |
| 4 | Environmental, traffic, disaster impact assessment act Article 4 |
| 5 | Environmental impact assessment act (old) Article 16 |
| 6 | Environmental, traffic, disaster impact assessment act Article 17 |
| 7 | Environmental impact assessment act (old) Article 17 |
| 8 | Environmental, traffic, disaster impact assessment act Article 19 |
| 9 | Environmental impact assessment act (old) Article 18 |
| 10 | Environmental, traffic, disaster impact assessment act Article 20 |
| 11 | Environmental impact assessment act (old) Article 19 |
| 12 | Environmental, traffic, disaster impact assessment act Article 21 |
| 13 | “ [symbol] ” (Administrative litigation law) Article 27 |

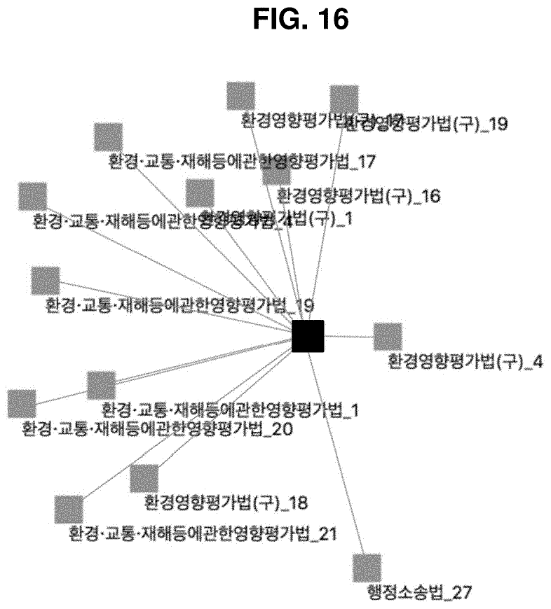

The citation relationships of the provisions may be visually expressed as in FIG. 16. The relationship between the case and the provisions is learned by the following procedures.

Step 1. a one-hot vector of the selected cases is constituted.

Step 2. a one-hot vector of the legislations that are cited by the selected cases is constituted.

Step 3. learning is made by constituting a learning dataset and disposing an input layer and an output layer.

Constituting a one-hot vector refers to making only one of the elements of a vector including 0 one. The constitution has to be present solely for each of the items, and the case and the legislations are separately classified and produced.

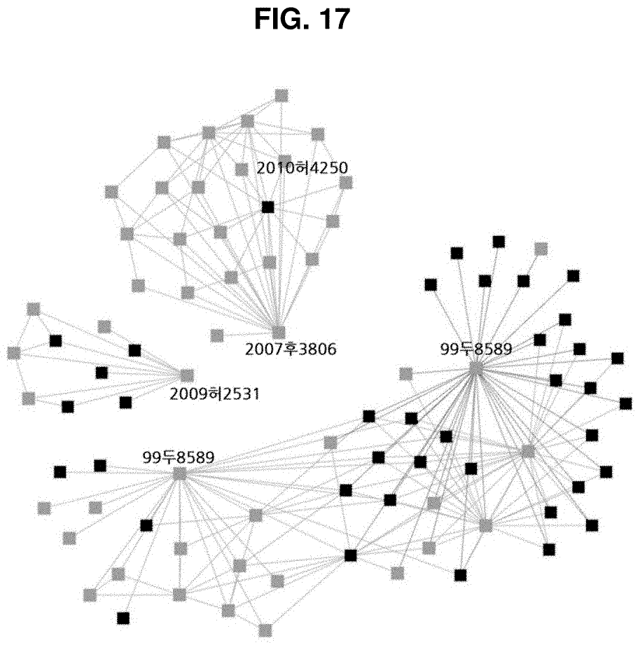

For example, let's learn five cases. Let's assume that case No. 99 Du 9902 corresponds to [1,0,0,0,0], case No. 99 Du 8589 corresponds to [0,1,0,0,0], case No. 2007 Hu 3806 corresponds to [0,0,1,0,0], case No. 2010 Her 4250 corresponds to [0,0,0,1,0], and case No. 2009 Her 2531 corresponds to [0,0,0.0,1]. The five case numbers have citation relationships with 40 provisions as can be seen in FIG. 17.

The lists of the legislations and the corresponding one-hot vectors are as in Table 6.

TABLE 6

| | Legislation | One-hot encoding vector |
|---|---|---|
| 1 | “ [symbol] ( [symbol] )” | [1, 0, 0, 0, 0, 0, 0, 0, 0, 0, 0, 0, 0, |
| | (Tourism | 0, 0, 0, 0, 0, 0, 0, 0, 0, 0, 0, 0, 0, 0, 0, 0, |
| | promotion act | 0, 0, 0, 0, 0, 0, 0, 0, 0, 0, 0] |
| | (old)) Article 1 | |
| 2 | Tourism promotion | [0, 1, 0, 0, 0, 0, 0, 0, 0, 0, 0, 0, 0, 0, |
| | act (old) | 0, 0, 0, 0, 0, 0, 0, 0, 0, 0, 0, 0, 0, 0, 0, |
| | Article 2 | 0, 0, 0, 0, 0, 0, 0, 0, 0, 0, 0] |
| 3 | Tourism promotion | [0, 0, 1, 0, 0, 0, 0, 0, 0, 0, 0, 0, 0, |
| | act (old) | 0, 0, 0, 0, 0, 0, 0, 0, 0, 0, 0, 0, 0, 0, 0, 0, |
| | Article 25 | 0, 0, 0, 0, 0, 0, 0, 0, 0, 0, 0] |
| 4 | Tourism promotion | [0, 0, 0, 1, 0, 0, 0, 0, 0, 0, 0, 0, 0, |
| | act Article 2 | 0, 0, 0, 0, 0, 0, 0, 0, 0, 0, 0, 0, 0, 0, 0, 0, |
| | | 0, 0, 0, 0, 0, 0, 0, 0, 0, 0, 0] |
| 5 | Tourism promotion | [0, 0, 0, 0, 1, 0, 0, 0, 0, 0, 0, 0, 0, 0, 0, |
| | act Article 53 | 0, 0, 0, 0, 0, 0, 0, 0, 0, 0, 0, 0, 0, 0, |
| | | 0, 0, 0, 0, 0, 0, 0, 0, 0, 0, 0] |
| 6 | “ [symbol] ( [symbol] )” | [0, 0, 0, 0, 0, 1, 0, 0, 0, 0, 0, 0, 0, 0, |
| | (Tourism promotion | 0, 0, 0, 0, 0, 0, 0, 0, 0, 0, 0, 0, 0, 0, 0, |
| | act decrement (old)) | 0, 0, 0, 0, 0, 0, 0, 0, 0, 0, 0] |
| | Article 22 | |
| 7 | “ [symbol] ( [symbol] )” | [0, 0, 0, 0, 0, 0, 1, 0, 0, 0, 0, 0, 0, 0, |
| | (Drinking water | 0, 0, 0, 0, 0, 0, 0, 0, 0, 0, 0, 0, 0, 0, 0, |
| | management act | 0, 0, 0, 0, 0, 0, 0, 0, 0, 0, 0] |
| | (old)) Article 2 | |
| 8 | Drinking water | [0, 0, 0, 0, 0, 0, 0, 1, 0, 0, 0, 0, 0, 0, |
| | management act | 0, 0, 0, 0, 0, 0, 0, 0, 0, 0, 0, 0, 0, 0, 0, |
| | (old) Article 5 | 0, 0, 0, 0, 0, 0, 0, 0, 0, 0, 0] |
| 9 | “ [symbol] ” | [0, 0, 0, 0, 0, 0, 0, 0, 1, 0, 0, 0, 0, 0, |
| | (Trademark law) | 0, 0, 0, 0, 0, 0, 0, 0, 0, 0, 0, 0, 0, 0, 0, |
| | Article 3 | 0, 0, 0, 0, 0, 0, 0, 0, 0, 0, 0] |
| 10 | Trademark law | [0, 0, 0, 0, 0, 0, 0, 0, 0, 1, 0, 0, 0, 0, 0, |
| | Article 7 | 0, 0, 0, 0, 0, 0, 0, 0, 0, 0, 0, 0, 0, 0, |
| | | 0, 0, 0, 0, 0, 0, 0, 0, 0, 0, 0] |
| 11 | Trademark law | [0, 0, 0, 0, 0, 0, 0, 0, 0, 0, 1, 0, 0, 0, 0, |
| | Article 71 | 0, 0, 0, 0, 0, 0, 0, 0, 0, 0, 0, 0, 0, 0, |
| | | 0, 0, 0, 0, 0, 0, 0, 0, 0, 0, 0] |
| 12 | Trademark law | [0, 0, 0, 0, 0, 0, 0, 0, 0, 0, 0, 1, 0, 0, 0, |
| | Article 73 | 0, 0, 0, 0, 0, 0, 0, 0, 0, 0, 0, 0, 0, 0, |
| | | 0, 0, 0, 0, 0, 0, 0, 0, 0, 0, 0] |
| 13 | Trademark law | [0, 0, 0, 0, 0, 0, 0, 0, 0, 0, 0, 0, 1, 0, |
| | Article 8 | 0, 0, 0, 0, 0, 0, 0, 0, 0, 0, 0, 0, 0, 0, 0, |
| | | 0, 0, 0, 0, 0, 0, 0, 0, 0, 0, 0] |
| 14 | “ [symbol] ” | [0, 0, 0, 0, 0, 0, 0, 0, 0, 0, 0, 0, 0, 1, 0, |
| | (Patent law) | 0, 0, 0, 0, 0, 0, 0, 0, 0, 0, 0, 0, 0, 0, |
| | Article 135 | 0, 0, 0, 0, 0, 0, 0, 0, 0, 0, 0] |
| 15 | Patent law | [0, 0, 0, 0, 0, 0, 0, 0, 0, 0, 0, 0, 0, 0, 1, |
| | Article 97 | 0, 0, 0, 0, 0, 0, 0, 0, 0, 0, 0, 0, 0, 0, |
| | | 0, 0, 0, 0, 0, 0, 0, 0, 0, 0, 0] |
| 16 | “ [symbol] ” | [0, 0, 0, 0, 0, 0, 0, 0, 0, 0, 0, 0, 0, 0, 0, |
| | (Administrative | 1, 0, 0, 0, 0, 0, 0, 0, 0, 0, 0, 0, 0, 0, |
| | suit law) | 0, 0, 0, 0, 0, 0, 0, 0, 0, 0, 0] |
| | Article 1 | |
| 17 | Administrative | [0, 0, 0, 0, 0, 0, 0, 0, 0, 0, 0, 0, 0, 0, 0, |
| | suit law Article 27 | 0, 1, 0, 0, 0, 0, 0, 0, 0, 0, 0, 0, 0, 0, |
| | | 0, 0, 0, 0, 0, 0, 0, 0, 0, 0, 0] |
| 18 | “ [symbol] , [symbol] , | [0, 0, 0, 0, 0, 0, 0, 0, 0, 0, 0, 0, 0, 0, 0, |
| | [symbol] | 0, 0, 1, 0, 0, 0, 0, 0, 0, 0, 0, 0, 0, 0, |
| | | 0, 0, 0, 0, 0, 0, 0, 0, 0, 0, 0] |
| | [symbol] ” | |
| | (Environmental, | |
| | traffic, | |
| | disaster impact | |
| | assessment act) | |
| | Article 1 | |
| 19 | Environmental, | [0, 0, 0, 0, 0, 0, 0, 0, 0, 0, 0, 0, 0, 0, 0, |
| | traffic, disaster | 0, 0, 0, 1, 0, 0, 0, 0, 0, 0, 0, 0, 0, 0, |
| | impact assessment | 0, 0, 0, 0, 0, 0, 0, 0, 0, 0, 0] |
| | act Article 17 | |
| 20 | Environmental, | [0, 0, 0, 0, 0, 0, 0, 0, 0, 0, 0, 0, 0, 0, 0, |
| | traffic, disaster | 0, 0, 0, 0, 1, 0, 0, 0, 0, 0, 0, 0, 0, 0, |
| | impact assessment | 0, 0, 0, 0, 0, 0, 0, 0, 0, 0, 0] |
| | act Article 19 | |
| 21 | Environmental, | [0, 0, 0, 0, 0, 0, 0, 0, 0, 0, 0, 0, 0, 0, 0, |
| | traffic, disaster | 0, 0, 0, 0, 0, 1, 0, 0, 0, 0, 0, 0, 0, 0, |
| | impact assessment | 0, 0, 0, 0, 0, 0, 0, 0, 0, 0, 0] |
| | act Article 20 | |
| 22 | Environmental, | [0, 0, 0, 0, 0, 0, 0, 0, 0, 0, 0, 0, 0, 0, 0, |
| | traffic, disaster | 0, 0, 0, 0, 0, 0, 1, 0, 0, 0, 0, 0, 0, 0, |
| | impact assessment | 0, 0, 0, 0, 0, 0, 0, 0, 0, 0, 0] |
| | act Article 21 | |
| 23 | Environmental, | [0, 0, 0, 0, 0, 0, 0, 0, 0, 0, 0, 0, 0, 0, |
| | traffic, disaster | 0, 0, 0, 0, 0, 0, 0, 0, 1, 0, 0, 0, 0, 0, 0, |
| | impact assessment | 0, 0, 0, 0, 0, 0, 0, 0, 0, 0, 0] |
| | act Article 4 | |
| 24 | Environmental, | [0, 0, 0, 0, 0, 0, 0, 0, 0, 0, 0, 0, 0, 0, |
| | traffic, disaster | 0, 0, 0, 0, 0, 0, 0, 0, 0, 1, 0, 0, 0, 0, 0, |
| | impact assessment | 0, 0, 0, 0, 0, 0, 0, 0, 0, 0, 0] |
| | act Article 5 | |
| 25 | Environmental, | [0, 0, 0, 0, 0, 0, 0, 0, 0, 0, 0, 0, 0, 0, 0, |
| | traffic, disaster | 0, 0, 0, 0, 0, 0, 0, 0, 0, 1, 0, 0, 0, 0, |
| | impact assessment | 0, 0, 0, 0, 0, 0, 0, 0, 0, 0, 0] |
| | act Article 6 | |
| 26 | Environmental, | [0, 0, 0, 0, 0, 0, 0, 0, 0, 0, 0, 0, 0, 0, 0, |
| | traffic, disaster | 0, 0, 0, 0, 0, 0, 0, 0, 0, 0, 1, 0, 0, 0, |
| | impact assessment | 0, 0, 0, 0, 0, 0, 0, 0, 0, 0, 0] |
| | act decrement | |
| | Article 2 | |
| 27 | “ [symbol] | [0, 0, 0, 0, 0, 0, 0, 0, 0, 0, 0, 0, 0, 0, 0, |
| | ( [symbol] )” | 0, 0, 0, 0, 0, 0, 0, 0, 0, 0, 0, 1, 0, 0, |
| | (Environmental | 0, 0, 0, 0, 0, 0, 0, 0, 0, 0, 0] |
| | impact | |
| | assessment act | |
| | (old) )Article 1 | |
| 28 | Environmental | [0, 0, 0, 0, 0, 0, 0, 0, 0, 0, 0, 0, 0, 0, |
| | impact assessment | 0, 0, 0, 0, 0, 0, 0, 0, 0, 0, 0, 0, 0, 1, 0, |
| | act (old) Article 16 | 0, 0, 0, 0, 0, 0, 0, 0, 0, 0, 0] |
| 29 | Environmental | [0, 0, 0, 0, 0, 0, 0, 0, 0, 0, 0, 0, 0, 0, 0, |
| | impact assessment | 0, 0, 0, 0, 0, 0, 0, 0, 0, 0, 0, 0, 0, 1, |
| | act (old) Article 17 | 0, 0, 0, 0, 0, 0, 0, 0, 0, 0, 0] |
| 30 | Environmental | [0, 0, 0, 0, 0, 0, 0, 0, 0, 0, 0, 0, 0, 0, |
| | impact assessment | 0, 0, 0, 0, 0, 0, 0, 0, 0, 0, 0, 0, 0, 0, 0, |
| | act (old) Article 18 | 1, 0, 0, 0, 0, 0, 0, 0, 0, 0, 0] |
| 31 | Environmental | [0, 0, 0, 0, 0, 0, 0, 0, 0, 0, 0, 0, 0, 0, |
| | impact assessment | 0, 0, 0, 0, 0, 0, 0, 0, 0, 0, 0, 0, 0, 0, 0, |
| | act (old) Article 19 | 0, 1, 0, 0, 0, 0, 0, 0, 0, 0, 0] |
| 32 | Environmental | [0, 0, 0, 0, 0, 0, 0, 0, 0, 0, 0, 0, 0, 0, 0, |
| | impact assessment | 0, 0, 0, 0, 0, 0, 0, 0, 0, 0, 0, 0, 0, 0, |
| | act (old) Article 4 | 0, 0, 1, 0, 0, 0, 0, 0, 0, 0, 0] |
| 33 | Environmental | [0, 0, 0, 0, 0, 0, 0, 0, 0, 0, 0, 0, 0, 0, 0, |
| | impact assessment | 0, 0, 0, 0, 0, 0, 0, 0, 0, 0, 0, 0, 0, 0, |
| | act (old) Article 8 | 0, 0, 0, 1, 0, 0, 0, 0, 0, 0, 0] |
| 34 | Environmental | [0, 0, 0, 0, 0, 0, 0, 0, 0, 0, 0, 0, 0, 0, |
| | impact assessment | 0, 0, 0, 0, 0, 0, 0, 0, 0, 0, 0, 0, 0, 0, 0, |
| | act (old) Article 9 | 0, 0, 0, 0, 1, 0, 0, 0, 0, 0, 0] |
| 35 | “ [symbol] | [0, 0, 0, 0, 0, 0, 0, 0, 0, 0, 0, 0, 0, 0, 0, |
| | ( [symbol] )” | 0, 0, 0, 0, 0, 0, 0, 0, 0, 0, 0, 0, 0, 0, |
| | (Environmental | 0, 0, 0, 0, 0, 1, 0, 0, 0, 0, 0] |
| | impact | |
| | assessment act | |
| | decrement (old)) | |
| | Article 2 | |
| 36 | “ [symbol] | [0, 0, 0, 0, 0, 0, 0, 0, 0, 0, 0, 0, 0, 0, |
| | ( [symbol] )” | 0, 0, 0, 0, 0, 0, 0, 0, 0, 0, 0, 0, 0, 0, 0, |
| | | 0, 0, 0, 0, 0, 0, 1, 0, 0, 0, 0] |
| | (Environmental | |
| | policy basic act | |
| | (old)) Article 1 | |
| 37 | Environmental | [0, 0, 0, 0, 0, 0, 0, 0, 0, 0, 0, 0, 0, 0, |
| | policy basic act | 0, 0, 0, 0, 0, 0, 0, 0, 0, 0, 0, 0, 0, 0, 0, |
| | (old) Article 10 | 0, 0, 0, 0, 0, 0, 0, 1, 0, 0, 0] |
| 38 | Environmental | [0, 0, 0, 0, 0, 0, 0, 0, 0, 0, 0, 0, 0, 0, 0, |
| | policy basic act | 0, 0, 0, 0, 0, 0, 0, 0, 0, 0, 0, 0, 0, 0, |
| | (old) Article 5 | 0, 0, 0, 0, 0, 0, 0, 0, 1, 0, 0] |
| 39 | Environmental | [0, 0, 0, 0, 0, 0, 0, 0, 0, 0, 0, 0, 0, 0, 0, |
| | policy basic act | 0, 0, 0, 0, 0, 0, 0, 0, 0, 0, 0, 0, 0, 0, |
| | (old) Article 6 | 0, 0, 0, 0, 0, 0, 0, 0, 0, 1, 0] |
| 40 | Environmental | [0, 0, 0, 0, 0, 0, 0, 0, 0, 0, 0, 0, 0, 0, 0, |
| | policy basic act | 0, 0, 0, 0, 0, 0, 0, 0, 0, 0, 0, 0, 0, 0, |
| | (old) Article | 7 0, 0, 0, 0, 0, 0, 0, 0, 0, 0, 1] |

That is, the values of the input layer and the output layer may be expressed with the citation relationship of Table 7.

The learning structure is called a CL model.

### 2) Case-Case (CC) Model

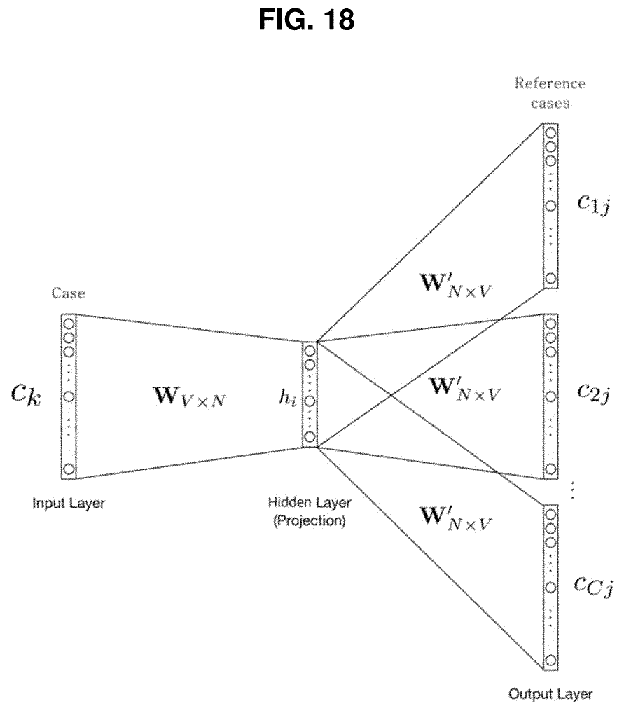

A case refers to a determination of a court that is written in a written judgment or a decision of a specific event. When it is asserted that the original written judgement contradicts the case of the supreme court, the case has to be expressed in detail. Accordingly, the cases often cite other cases. Further, the cases may have ‘a constraint as a precedent’, and accordingly, many cases cite the past cases. Accordingly, the inventors suggested a CC model as in FIG. 18 based on a citation relationship of the cases.

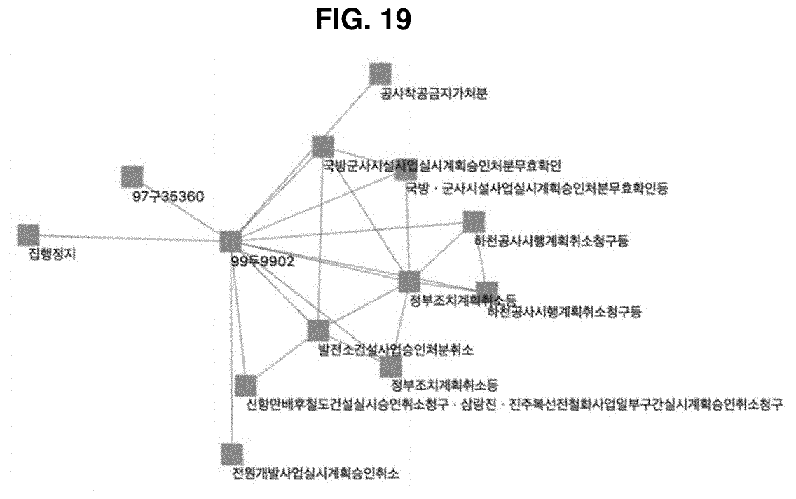

For example, case No. 99 Du 9002 cites many cases as in FIG. 19. The citation relationship is learned as in a CL model.

### 3) Case-Legislation-Case (CLC) Model

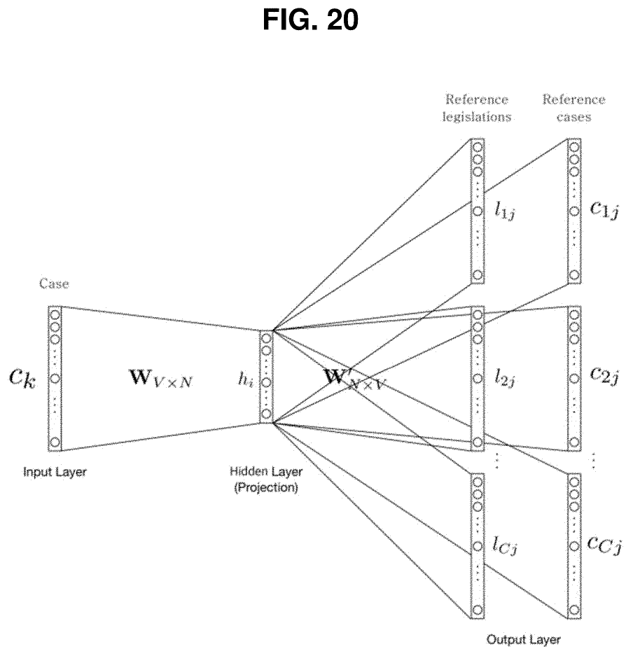

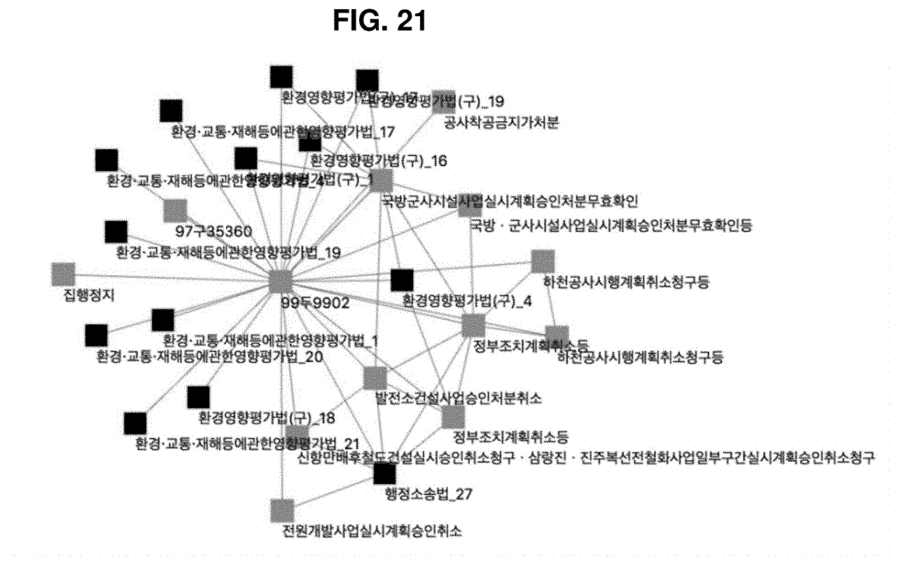

If a legislation was a frame of a law, a case is a muscle that is added to the frame. The case supplements the legislation, and additionally acts as a guide as to how the legislation has to be interpreted. Accordingly, as in FIG. 21, one case cites provisions and existing cases, and the inventors suggested a CLC model as in FIG. 20, in which both two forms of data is learned.

### Verification of Performance

### 1. Description of Operations

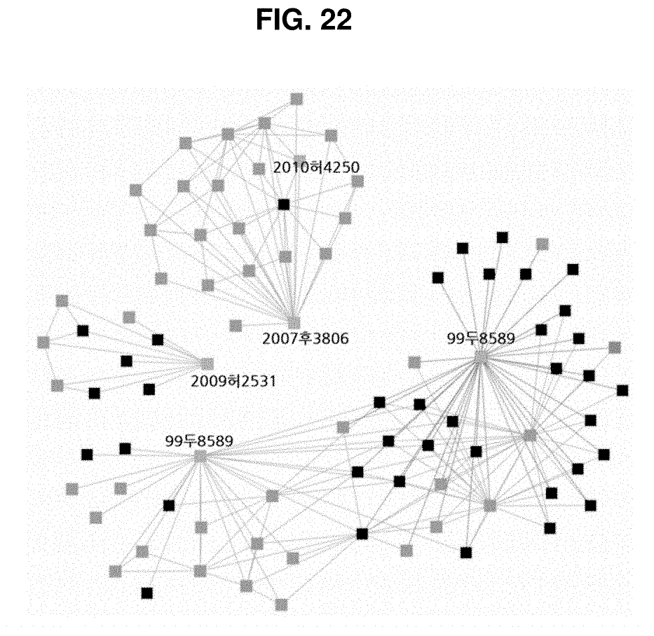

First, five sample cases are selected and the relationship of the sample cases is learned to verify the performance of the suggested method. In FIG. 22, the purple node indicates a selected sample case, the blue color indicates a cited case, and the red color indicates a cited legislation.

a. Let's assume that the following pair of cases are solutions when a lawyer makes a decision after viewing the contents of the case. (case No. 99 Du 9902, case No. 99 Du 8589), (case No. 2007 Hu 3806, case No. 2010 Her 4250), and (case No. 2009 Her 2531)
b. Let's review a result after applying the cases to the CL, CC, and CLC models and comparing them.

### 2. Verification of a CL Model

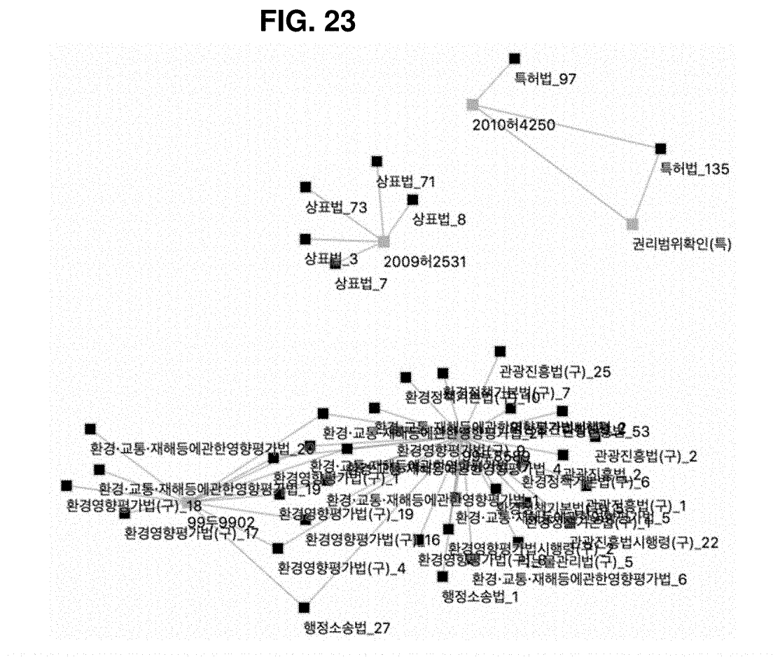

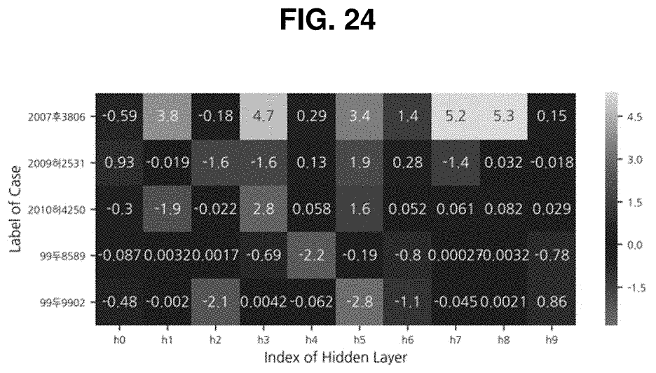

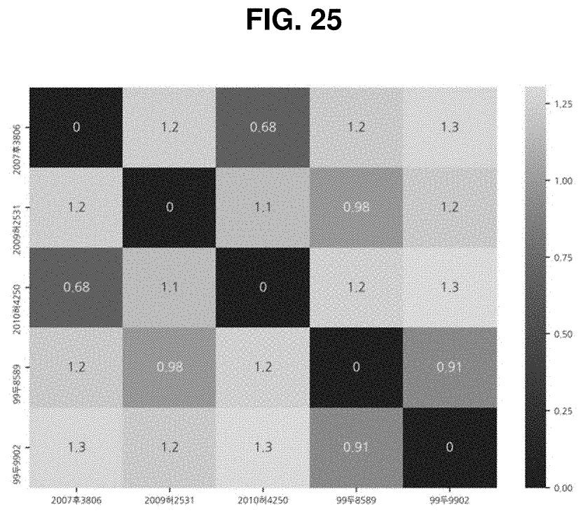

The case-legislation citation relationships of five selected sample cases are as in FIG. 23. A result may be as in FIG. 24 when learning is made only with provisions that are cited for the five selected sample cases, and it may be said that the similarities of the sample cases are well learned as can be seen in FIG. 25.

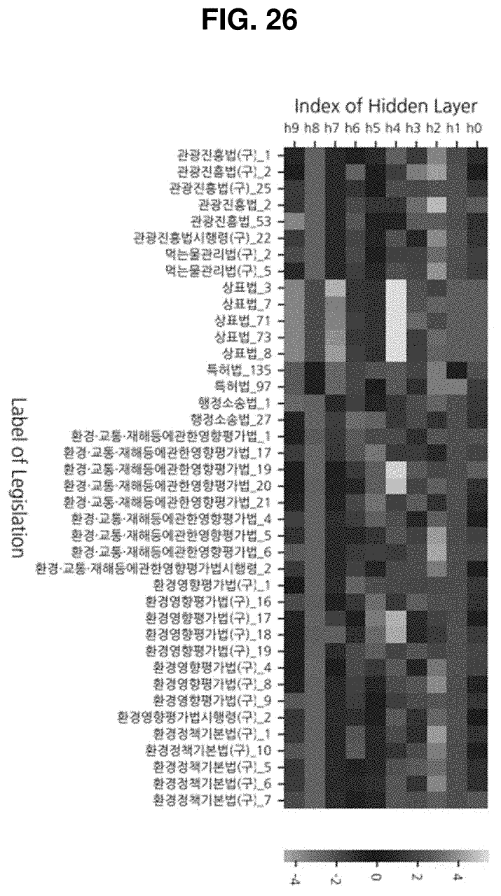

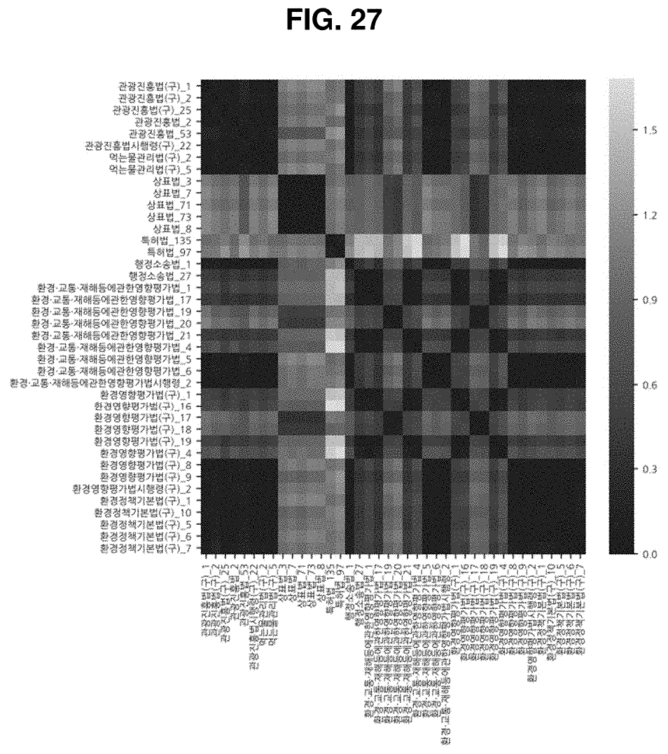

Further, as can be seen in FIGS. 26 to 27, the legislations are well learned according to the properties thereof in matrix W2.

### 3. Verification of a CC Model

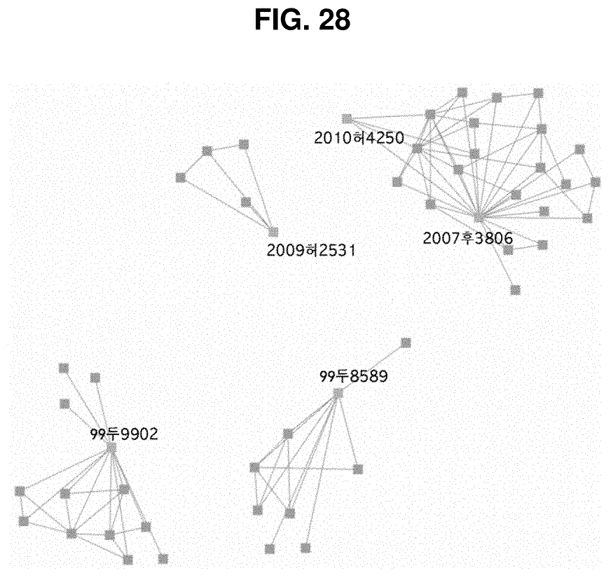

The case-legislation citation relationships of five selected sample cases are as in FIG. 28. Here, it may be recognized that case Nos. 99 Du 9902 and 99 Du 8589 that are solution data are not connected to each other.

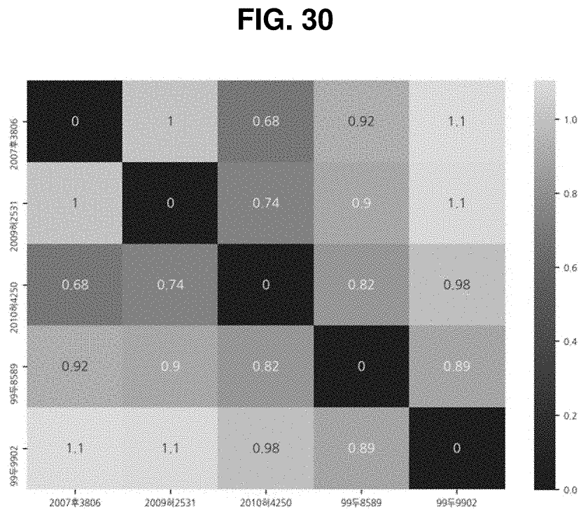

As a result, it can be seen recognized that case Nos. 2010 Her 4250 and 2007 Hu 3806 actually have a high similarity as can be seen in FIG. 30, but the other cases do not have unique values.

### 4. Verification of a CLC Model

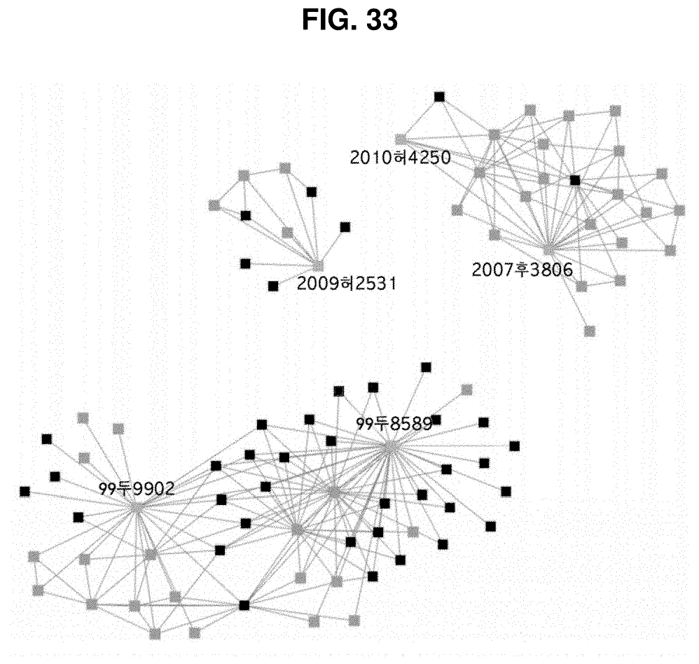

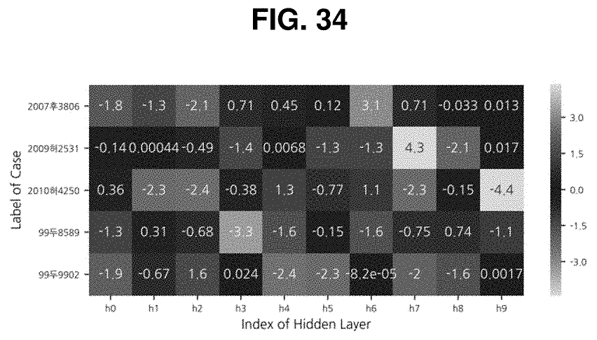

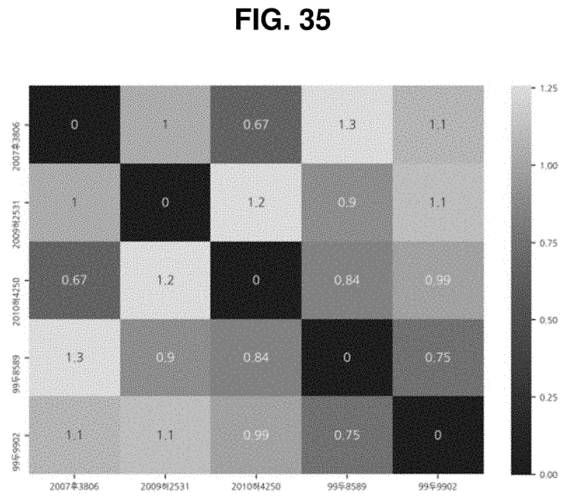

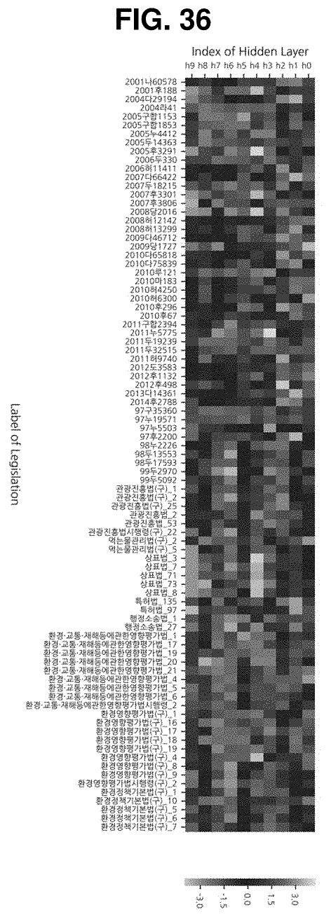

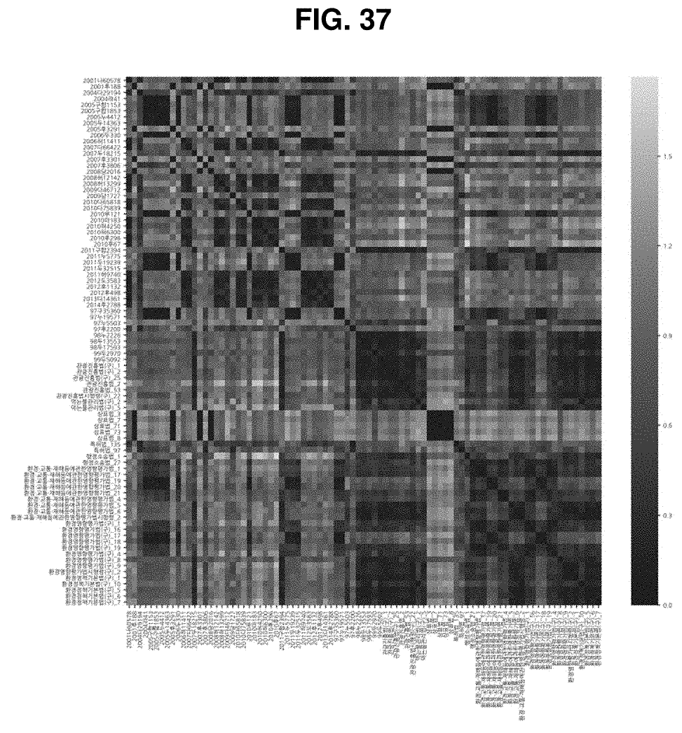

The case-legislation citation relationships of five selected sample cases are as in FIG. 33. As can be seen in FIGS. 34 to 38, it can be seen that the result are outstandingly well learned for the solution. In particular, it can be identified that a part that has not been learned in the CC model is well supplemented.

### 5. Comparison of Models

Finally, let's collect and review the results. The similarities for the solutions in the three suggested models are as in Table 8. Here, a result obtained by calculating a similarity by constituting a TF-IDF in a word-based method is included.

TABLE 8

| | Similarity | | | |
|---|---|---|---|---|
| Gold standard Pair | CL | CC | CLC | Word |
| 2007 Hu 3806, 2010 Her 4250 | 0.68 | 0.68 | 0.67 | 0.42 |
| 99 Du 8589, 99 Du 9902 | 0.91 | 0.89 | 0.75 | 1.3 |

In the word-based method, it may be recognized that the similarity of case Nos.

2007 Hu 3806 and 2010 Her 425 is a high value of 0.42 (it shows that they are most similar when the similarity value is 0). However, it can be seen that the similarity of case Nos. 99 Du 8589 and 99 Du 9902 is 1.3 and they are hardly relevant. This is because the coincidence of the words of the two cases is very low, and the contents may be identified in Table 9. It may be identified that the performance of legal relationship-based learning is much higher than the performance of the existing word-based method, through the result.

TABLE 9

| Case | |
|---|---|
| number | Texts such as written judgments |
| 99 Du | [1] When a legal feature of allowance |
| 8589 | of enforcement of a tour area |
| | construction business (= a discretionary |
| | act), a target of a judicial |
| | examination of a court regarding the |
| | legal feature (violation of |
| | deviation/abuse of a discretionary right), |
| | and a discretionary act of an |
| | administrative office are based on a |
| | misunderstanding of a fact, whether |
| | they correspond to deviation/abuse of a |
| | discretionary right and violate a law |
| | (actively) |
| | [2] An example in which for the reasons |
| | that in spite that conditions such as |
| | installation of wasting water processing |
| | facilities are included in the |
| | permission of enforcement of the tour area |
| | construction business, the effects |
| | of the facilities are obscure and wasting |
| | water cannot be certainly purified so |
| | that the drinking water for the nearby |
| | residents may be contaminated and the |
| | environmental benefits of the residents |
| | may be infringed, the infringement |
| | of the environmental benefits exceeds |
| | an allowable limit when compared |
| | with the case before the tour area was |
| | developed in terms of socially |
| | accepted rationale, and the environmental |
| | benefits of the residents are more |
| | excellent than the commercial benefits |
| | of the businesses or vacationers or |
| | benefits of enjoyment of leisure activities |
| | due to the permission of the |
| | enforcement of enforcement of the tour |
| | area construction business, the |
| | permission of the enforcement of |
| | enforcement of the tour area construction |
| | business deviated and abused the discretionary |
| | right based on a misunderstanding of the facts |
| | [1] The enforcement of a tour area is an |
| | act that influences maintenance of |
| | the territory and the nature and |
| | preservation of an environment, and the |
| | permission of the enforcement of a |
| | tour area pertains to a kind of a |
| | discretionary act that has to be determined |
| | in comprehensive consideration |
| | of a reality and a location of a business |
| | place and a surrounding situation, a |
| | timing of the enforcement of the business |
| | and a suitableness of a subject, the |
| | contents, the scale, and the method of |
| | the business that appears in the |
| | business plan, and their influences on |
| | the nature and the environment, and |
| | the legal examination of the court on the |
| | discretionary act includes only |
| | examination of whether the corresponding |
| | act pertains to deviation and |
| | abuse of the discretionary act based |
| | on a misunderstanding of a fact, |
| | violation of the principle of proportion |
| | and equality, and violation of the |
| | purpose of the corresponding act or an |
| | illegal motive, or the like, but the |
| | discretionary act is admitted to pertain |
| | to deviation and abuse of the |
| | discretionary act when the examination |
| | result of the court admits that the |
| | discretionary act of the administrative |
| | office is based on a misunderstanding |
| | of a fact or the like so that the |
| | discretionary act has to be cancelled. |
| | [2] An example in which for the reasons |
| | that in spite that conditions such as |
| | installation of wasting water processing |
| | facilities are included in the |
| | permission of enforcement of the tourist |
| | area construction business, the |
| | effects of the facilities are obscure and |
| | wasting water cannot be certainly |
| | purified so that the drinking water |
| | for the nearby residents may be |
| | contaminated and the environmental |
| | benefits of the residents may be |
| | infringed, the infringement of the |
| | environmental benefits exceeds an |
| | allowable limit when compared with |
| | the case before the tourist area was |
| | developed in terms of socially accepted |
| | rationale, and the environmental |
| | benefits of the residents are more excellent |
| | than the commercial benefits of |
| | the businesses or vacationers or benefits |
| | of enjoyment of leisure activities |
| | due to the permission of the enforcement |
| | of enforcement of the tourist area |
| | construction business, the permission of |
| | the enforcement of enforcement of |
| | the tourist area construction business |
| | deviated and abused the discretionary |
| | right based on a misunderstanding of the facts |
| 99 Du | [1] When the contents of an environment |
| 9902 | impact assessment are poor in |
| | spite that an environment impact |
| | assessment procedure determined in |
| | Environmental impact assessment act |
| | (old) was performed, whether an |
| | administrative measure for a target |
| | business of an environmental impact |
| | assessment is illegal due to the |
| | poor contents (limited, passive) |
| | [2] An example in which it is not admitted |
| | that the approval measure of an |
| | enforcement plan of a business is illegal |
| | for the reason why the measure is |
| | not the one which is considered not |
| | to perform an environmental impact |
| | assessment on a construction business |
| | of a repair garage for express trains of |
| | Korea Train Express because the |
| | contents of the environmental impact |
| | assessment is poor not enough to |
| | achieve the legislative purpose of the |
| | environmental impact assessment institute |
| | [1] In view of the purpose of determining |
| | businesses in which an |
| | environmental impact assessment is to |
| | be carried out in Article 4 of |
| | Environmental impact assessment act |
| | (old) (before revision of Law No. |
| | 5302 in Mar. 7, 1997) and making |
| | an environmental impact assessment |
| | essential for a target business in Articles |
| | 16 to 19, the measure is illegal if |
| | the approval was made in spite that |
| | the environmental impact assessment |
| | was not made on the target business |
| | on which an environmental impact |
| | assessment determined in the same |
| | act has to be performed, the poor |
| | contents correspond only to one element |
| | for determining whether there was |
| | an illegal act of deviation and abuse |
| | of the discretionary act in the measure |
| | and the measure, such as the approval, |
| | is not admitted to be illegal due to the |
| | poor contents unless the poor contents |
| | pertain to the one that is almost the |
| | same as not carrying out the environment |
| | impact assessment because the |
| | poor degree cannot achieve the legislative |
| | purpose of the environmental |
| | impact assessment institute even |
| | though the contents of the environmental |
| | impact assessment is somewhat |
| | poor if the procedure was made |
| | [2] An example in which it is not admitted |
| | that the approval measure of an |
| | enforcement plan of a business is illegal |
| | for the reason why the measure is |
| | not the one which is considered not |
| | to perform an environmental impact |
| | assessment on a construction business |
| | of a repair garage for express trains of |
| | Korea Train Express because the |
| | contents of the environmental impact |
| | assessment is poor not enough to |
| | achieve the legislative purpose of the |
| | environmental impact assessment institute |

### Prediction of a Link

The inventors performs learning in a large-scale set to utilize the suggested model in an actual product/service. The learning data includes a total of 148,325 cases and 47,444 provisions and is constituted as in Table 10. Further, in order to evaluate the performance, the enrolled barrister and solicitor of the High Court of New Zealand directly produced 300 similar case evaluation datasets, and the performances of the learning for the datasets were evaluated.

TABLE 10

| Category | # of Relations | # of Learning set |
|---|---|---|
| CL | 73,211 | 326,136 |
| CC | 145,100 | 427,793 |
| CLC | 148,325 | 753,929 |

### 1. CL Model

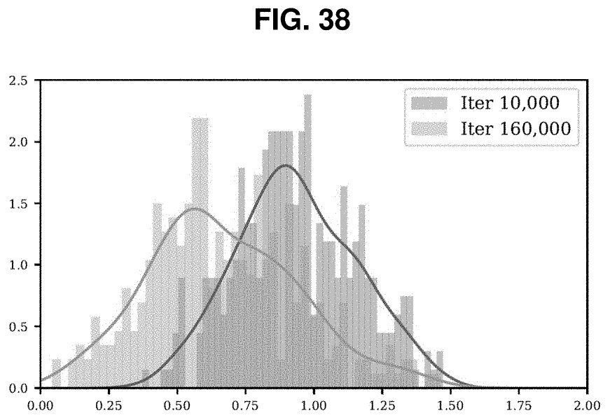

In FIG. 38, a process of learning a large-scale set using a CL model is illustrated. It may be identified that the similarity may be accurately calculated by using a CL model in learning. The same legislation is cited in a plurality of cases because the corresponding case may deal with the same legal subject or problem with a high possibility. An answer distribution started from a value that is close to 2 when learning is repeated 10,000 times, but the response distribution approached 0 after learning is repeated 160,000 times. 0 represents the best result.

### 2. CC Model

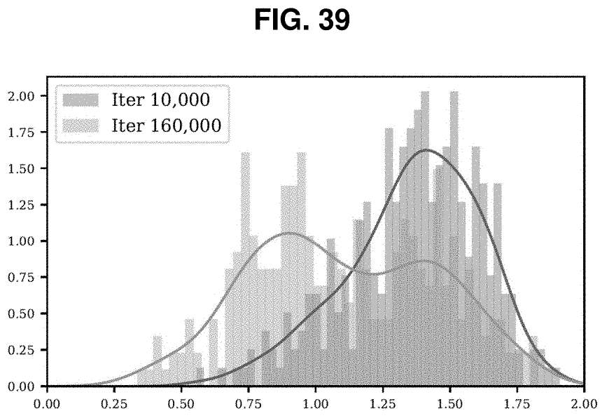

In FIG. 39, a process of learning a large-scale set using a CC model is illustrated. In the CC model, learning was not made well. The inventors interpreted that the result was caused because the response set often includes cases that never cite other cases.

### 3. CLC Model

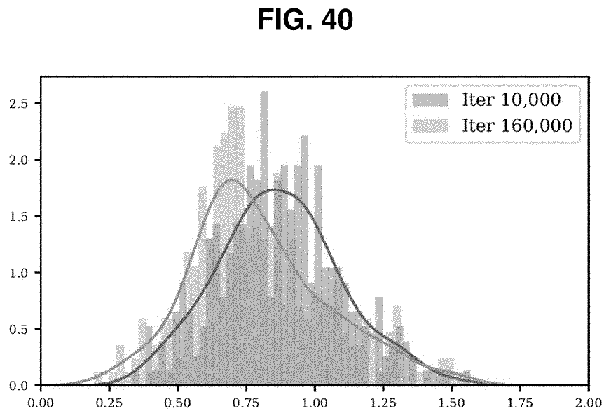

In FIG. 40, a process of learning a large-scale set using a CLC model is illustrated. Because the CLC model utilized both case citation and legislation citation, the amount of the learning data is larger than those of the other two models. Accordingly, it can be seen that the progress of the learning is very slow. However, it can be identified that the response distribution becomes almost 0 when learning is repeated 160,000 times while the learning is progressed.

Table 11 represents an average similarity of Law2Vec models for large-scale sets.

TABLE 11

| | Iteration | | | |
|---|---|---|---|---|
| Type | 10,000 | 160,000 | 180,000 | 190,000 |
| CL | 0.936 | 0.669 | 0.667 | — |
| CC | 1.363 | 1.107 | 1.103 | 1.101 |
| CLC | 0.871 | 0.798 | — | — |

### 4. Application

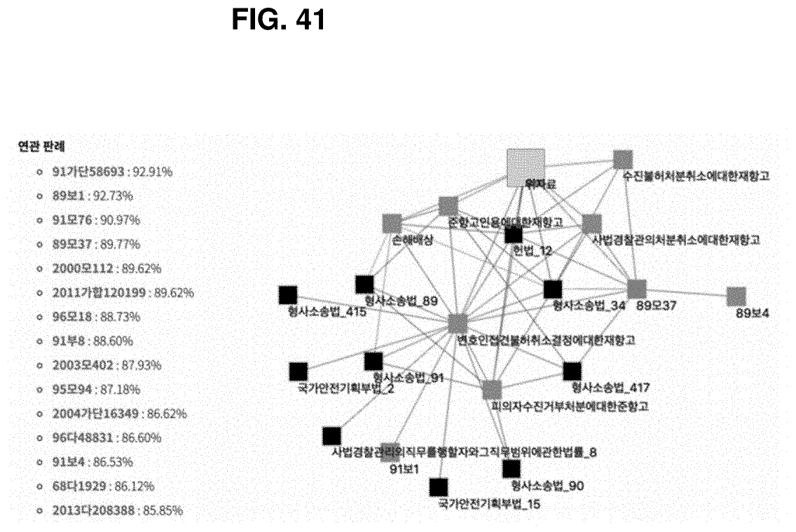

A link predicting product of FIG. 41 may be provided based on the result. If the similarity of contents is high based on the Law2Vec result for the cases that have no direct citation relationships for the cases (green boxes) selected in FIG. 41 is high, they may be connected by green lines to represent the similarity. That is, a prediction result for the similarity of the contents may be expressed by expressing the links with green lines to show that there is a relevance in spite that there is no link.

### Conclusion and Effect

In the suggested Law2Vec method, the similarity of documents is excellently calculated as compared with the conventional word-based methods. The reason is that the word-based methods cannot solve the problems based on the features of the languages, such as synonyms and polysemy but in the suggested Law2Vec method, the cited provisions and the cited cases may excellently deal with the principles of the laws or the fact relationships that are determined by the judges. The advantage of the method based on the citation relationships is that the similarity of the contents may be calculated and the contents of the unopened cases may be predicted. Although a large number of cases are produced every day in Korea, an extremely small number of cases are opened. This is because of a difficulty of deletion of private information of the cases due to a private information protection law. Currently, about 77,000 cases have been opened, and a total of 148,000 cases, including cases that cite the opened cases, have been opened. That is, series numbers of the cited cases through the opened cases are often viewed, but about 70,000 cases that are not opened cannot be viewed. However, in the calculation of the similarity of the contents learned through the suggested Law2Vec method, the contents may be inferred even though the cases are not opened because the similarity of the contents may be calculated only with the citation relationship.

Further, as can be seen from the experiment result, the similarity of the contents of the provisions may be calculated through matrix W2. Because the texts of the provisions are written such that each of the articles has one meaning, the provisions include very brief contents. Accordingly, it is difficult to recognize the meanings and usages of the provisions only with the word-based analysis method. However, because the similarity of the provisions also may be calculated through the learning of the citation relationships of the cases, the similarity of the meanings of the provisions also may be advantageously calculated.

In summary, the advantage of Law2Vec is as follows.

The similarity of the cases may be calculated more accurately by calculating the similarity of the contents of the cases by using the citation relationship of the cases or legislations without calculating the similarity of the contents of the cases based on keywords in a traditional scheme.

Further, another case having similar contents may be discovered by calculating the above-mentioned similarity only by using the citation relationship of the cases or legislations even when the contents of the cases are not opened (for the reason of protection of private information).

The similarity of the contents of the provisions of the legislation that is abstract and complex only with the core words by using the citation relationship of the cases or legislations (to the contrary, with the assumption that the legislations cited by similar cases are similar).

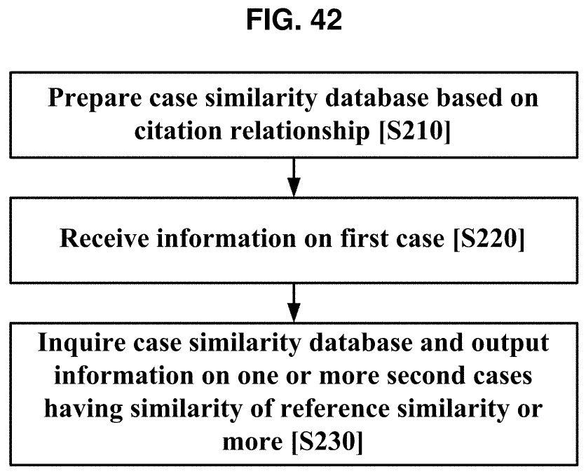

FIG. 42 is a flowchart schematically illustrating a method for providing similar case information based on a citation relationship according to another embodiment of the inventive concept.

Referring to FIG. 42, the method for providing similar case information includes an operation (S210) of preparing a case similarity database based on a citation relationship, an operation (S220) of receiving information on a first case, and an operation (S230) of inquiring the case similarity database and outputting information on one or more second cases having a similarity of a specific reference similarity with the first case.

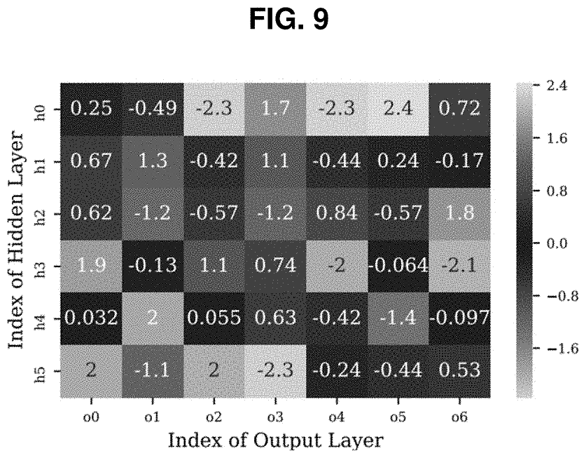

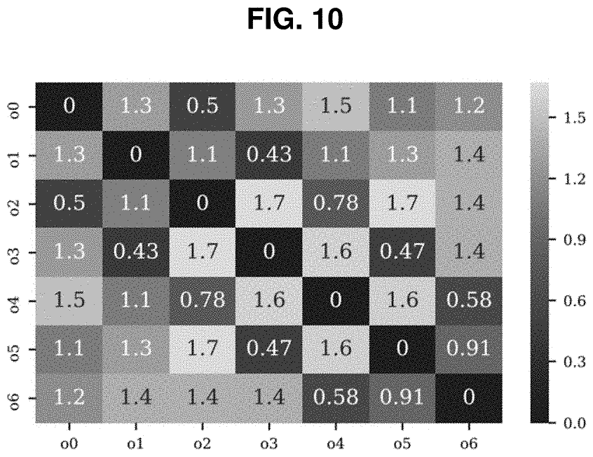

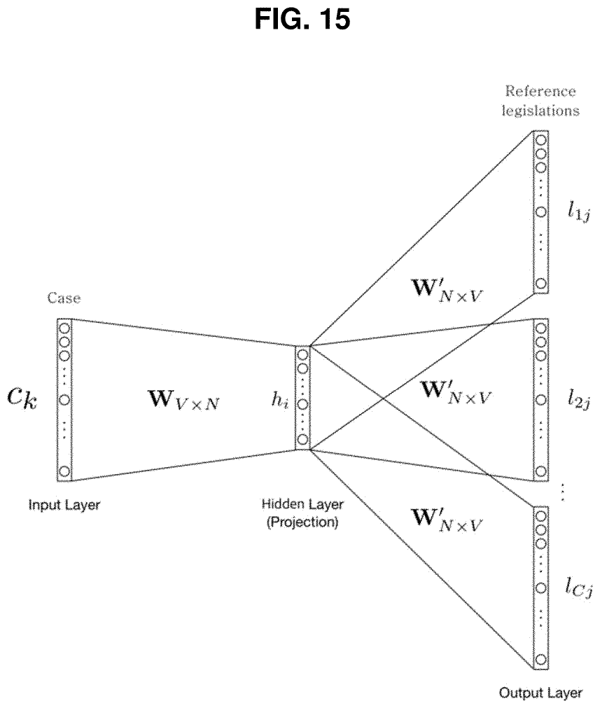

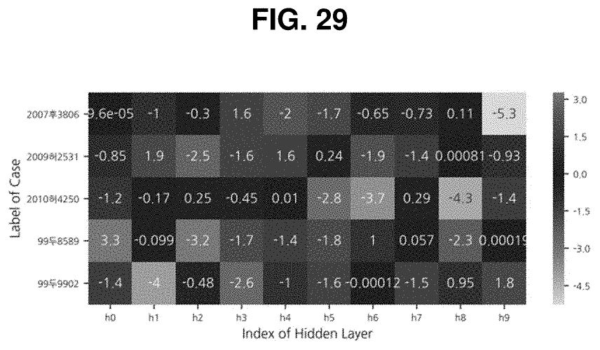

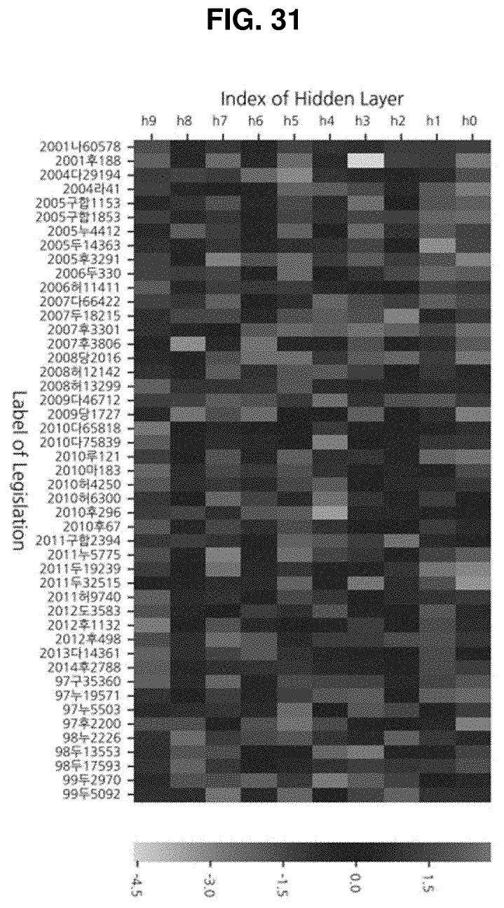

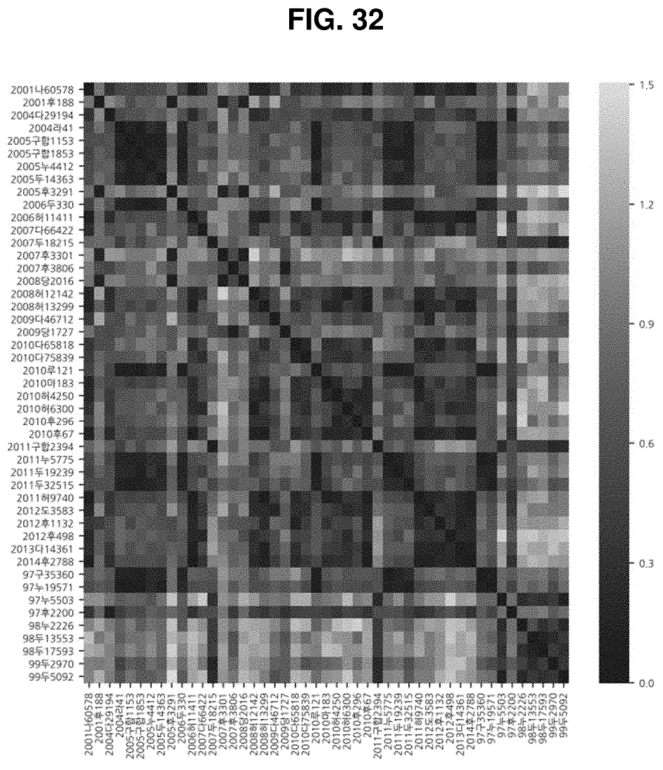

The case similarity database based on the citation relationship is produced through the method for calculating a similarity of cases based on a citation relationship described with reference to FIGS. 1 to 41.

As described above, according to the method, even when there is no direct citation relationship between the first case and the second case, information on the second case having a similarity of a specific reference similarity or more with the first case may be provided.

Further, as described above, according to the method, even when a provision of a legislation cited on a written judgment of the first case or the second case or another case is opened and the contents of the written judgment is not opened, information on the second case having a similarity of a specific reference similarity or more with the first case may be provided.

The computer device may include a processor that processes data, and a memory that stores data and various programs.

The processor may perform a program that includes an instruction for performing the above-described method for calculating a similarity of cases based on a citation relationship. Further, the processor may perform a program that includes an instruction for performing the above-described method for providing similar case information based on a citation relationship.

The computer device may further include a communication module. The computer device may be connected to a network through the communication module and may communicate with another computer device through a network. The computer device may receive information on a first case from another computer device, and may output information on a second case to another computer device.

The steps of a method or an algorithm that have been described in relation to the embodiments of the inventive concept may be directly implemented by hardware, may be implemented by a software module executed by hardware, or may be implemented by a combination thereof. The software module may reside in a random access memory (RAM), a read only memory (ROM), an erasable programmable ROM (EPROM), an electrically erasable programmable ROM (EEPROM), a flash memory, a hard disk, a detachable disk, a CD-ROM, or a computer readable recording medium in an arbitrary form, which is well known in the art to which the inventive concept pertains.

According to the inventive concept, the similarity of the cases may be calculated more accurately by calculating the similarity of the contents of the cases by using the citation relationship of the cases or legislations without calculating the similarity of the contents of the cases based on keywords in a traditional scheme.

Further, according to the inventive concept, another case having similar contents may be discovered by calculating the above-mentioned similarity only by using the citation relationship of the cases or legislations even when the contents of the cases are not opened (for the reason of protection of private information).

Further, according to the inventive concept, the similarity of the contents of the provisions of the legislation that is abstract and complex only with the core words by using the citation relationship of the cases or legislations (to the contrary, with the assumption that the legislations cited by similar cases are similar).

The aspect of the inventive concept is not limited thereto, and other unmentioned aspects of the inventive concept may be clearly appreciated by those skilled in the art from the following descriptions. Although the exemplary embodiments of the inventive concept have been described with reference to the accompanying drawings, it will be understood by those skilled in the art to which the inventive concept pertains that the inventive concept can be carried out in other detailed forms without changing the technical spirits and essential features thereof. Therefore, the above-described embodiments are exemplary in all aspects, and should be construed not to be restrictive.

What is claimed is:

1. A method for calculating a similarity of cases based on a citation relationship, the method being realized by a computer, the method comprising:
receiving a learning dataset on specific cases;
machine-learning the learning dataset by using a neural network learning model; and
calculating a similarity of the specific cases according to a machine-learning result,
wherein the learning dataset includes:
an input layer in which each of identifiers of the specific cases includes a one-hot vector; and
an output layer in which each of identifiers of one or more provisions of a legislation cited on written judgments of the cases includes a one-hot vector.

2. A method for calculating a similarity of cases based on a citation relationship, the method being realized by a computer, the method comprising:
receiving a learning dataset on specific cases;
machine-learning the learning dataset by using a neural network learning model; and
calculating a similarity of cases according to a machine-learning result,
wherein the learning dataset includes:
an input layer in which each of identifiers of the specific cases includes a one-hot vector; and
an output layer in which each of identifiers of one or more other cases cited on written judgments of the specific cases includes a one-hot vector.

3. A method for calculating a similarity of cases based on a citation relationship, the method being realized by a computer, the method comprising:
receiving a learning dataset on specific cases;
machine-learning the learning dataset by using a neural network learning model; and
calculating a similarity of cases according to a machine-learning result,
wherein the learning dataset includes:
an input layer in which each of identifiers of the specific cases includes a one-hot vector; and
a first output layer in which each of identifiers of one or more provisions of a legislation cited on written judgments of the cases includes a one-hot vector; and
a second output layer in which each of identifiers of one or more other cases cited on the written judgments of the specific cases includes a one-hot vector.

4. A computer program that is coupled to a computer and is recorded in a computer readable recording medium to perform the method for calculating a similarity of cases based on a citation relationship as claimed in claim 1.

5. A computer program that is coupled to a computer and is recorded in a computer readable recording medium to perform the method for calculating a similarity of cases based on a citation relationship as claimed in claim 2.

6. A computer program that is coupled to a computer and is recorded in a computer readable recording medium to perform the method for calculating a similarity of cases based on a citation relationship as claimed in claim 3.

7. A computer device comprising:
a processor configured to process data; and
a memory configured to store data,
wherein the processor is configured to:
perform a program for calculating a similarity of cases based on a citation relationship, and
wherein the program includes an instruction for performing a method for calculating a similarity of cases based on a citation relationship as claimed in claim 1.

8. A computer device comprising:
a processor configured to process data; and
a memory configured to store data,
wherein the processor is configured to:
perform a program for calculating a similarity of cases based on a citation relationship, and
wherein the program includes an instruction for performing a method for calculating a similarity of cases based on a citation relationship as claimed in claim 2.

9. A computer device comprising:
a processor configured to process data; and
a memory configured to store data,
wherein the processor is configured to:
perform a program for calculating a similarity of cases based on a citation relationship, and
wherein the program includes an instruction for performing a method for calculating a similarity of cases based on a citation relationship as claimed in claim 3.

10. A method for providing similar case information based on a citation relationship, the method being generated by a method for calculating a similarity of cases based on the citation relationship, the method being realized by a computer, the method comprising:
preparing a case similarity database based on a citation relationship;
receiving information on a first case; and
inquiring the case similarity database to output information on one or more second cases having a similarity of a specific reference similarity or more with the first case,
wherein the preparing of the case similarity database based on a citation relationship includes:
receiving a learning dataset on specific cases;
machine-learning the learning dataset by using a neural network learning model; and
calculating a similarity of cases according to a machine-learning result, and
wherein the learning dataset includes:
an input layer in which each of identifiers of the specific cases includes a one-hot vector; and
an output layer in which each of identifiers of one or more provisions of a legislation cited on written judgments of the cases includes a one-hot vector.

11. A method for providing similar case information based on a citation relationship, the method being generated by a method for calculating a similarity of cases based on the citation relationship, the method being realized by a computer, the method comprising:
preparing a case similarity database based on a citation relationship;
receiving information on a first case; and
inquiring the case similarity database to output information on one or more second cases having a similarity of a specific reference similarity or more with the first case,
wherein the preparing of the case similarity database based on a citation relationship includes:
receiving a learning dataset on specific cases;
machine-learning the learning dataset by using a neural network learning model; and
calculating a similarity of cases according to a machine-learning result, and
wherein the learning dataset includes:
an input layer in which each of identifiers of the specific cases includes a one-hot vector; and
an output layer in which each of identifiers of one or more other cases cited on written judgments of the specific cases includes a one-hot vector.

12. A method for providing similar case information based on a citation relationship, the method being generated by a method for calculating a similarity of cases based on the citation relationship, the method being realized by a computer, the method comprising:
preparing a case similarity database based on a citation relationship;
receiving information on a first case; and
inquiring the case similarity database to output information on one or more second cases having a similarity of a specific reference similarity or more with the first case,
wherein the preparing of the case similarity database based on a citation relationship includes:
receiving a learning dataset on specific cases;
machine-learning the learning dataset by using a neural network learning model; and
calculating a similarity of cases according to a machine-learning result, and
wherein the learning dataset includes:
an input layer in which each of identifiers of the specific cases includes a one-hot vector; and
a first output layer in which each of identifiers of one or more provisions of a legislation cited on written judgments of the cases includes a one-hot vector; and
a second output layer in which each of identifiers of one or more other cases cited on written judgments of the specific cases includes a one-hot vector.

13. A computer program that is coupled to a computer and is recorded in a computer readable recording medium to perform the method for providing similar case information based on a citation relationship as claimed in claim 10.

14. A computer program that is coupled to a computer and is recorded in a computer readable recording medium to perform the method for providing similar case information based on a citation relationship as claimed in claim 11.

15. A computer program that is coupled to a computer and is recorded in a computer readable recording medium to perform the method for providing similar case information based on a citation relationship as claimed in claim 12.

16. A computer device comprising:
a processor configured to process data; and
a memory configured to store data,
wherein the processor is configured to:
perform a program for providing similar case information based on a citation relationship, and
wherein the program includes an instruction for performing a method for providing similar case information based on a citation relationship as claimed in claim 10.

17. A computer device comprising:
a processor configured to process data; and
a memory configured to store data,
wherein the processor is configured to:
perform a program for providing similar case information based on a citation relationship, and
wherein the program includes an instruction for performing a method for providing similar case information based on a citation relationship as claimed in claim 11.

18. A computer device comprising:
a processor configured to process data; and
a memory configured to store data,
wherein the processor is configured to:
perform a program for providing similar case information based on a citation relationship, and
wherein the program includes an instruction for performing a method for providing similar case information based on a citation relationship as claimed in claim 12.
